(19) United States
(12) Patent Application Publication
(10) Pub. No.: US 2026/0019980 A1
(43) Pub. Date: Jan. 15, 2026

(54) SIGNALING OF UE ADDITIONAL CONDITIONS FOR CHANNEL RESPONSE GENERATION AND SAMPLING

(71) Applicant: QUALCOMM Incorporated, San Diego, CA (US)

(72) Inventors: Mohammed Ali Mohammed HIRZALLAH, San Marcos, CA (US); Taesang YOO, San Diego, CA (US)

(21) Appl. No.: 18/772,048

(22) Filed: Jul. 12, 2024

(51) Int. Cl. H04W 64/00

(52) U.S. Cl. CPC H04W 64/00

(57) ABSTRACT

Aspects presented herein may enable a wireless device (e.g., a user equipment (UE), a base station/transmission reception point (TRP), etc.) to indicate measurement processing done by the wireless device using indexing/brief information when reporting measurements for artificial intelligence (AI) or machine learning (ML) (AI/ML) model input without revealing confidential/proprietary information, thereby ensuring a consistency between AI/ML positioning models and other reporting entities/nodes as well as a consistency between training and inference for a given AI/ML positioning model. In one aspect, a wireless device processes a set of reference signal (RS) measurements based on a set of processing parameters to obtain a time-domain channel response associated with the set of RS measurements. The wireless device transmits, to a network entity, the time-domain channel response and an index indicative of the set of processing parameters.

### TECHNICAL FIELD

The present disclosure relates generally to communication systems, and more particularly, to wireless communication involving artificial intelligence (AI) or machine learning (ML) (AI/ML) positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Some telecommunication standards also provide positioning protocols and techniques that enable mobile network operators to provide high-accuracy location services to their subscribers. For example, 5G NR include various standards for network-based positioning that use signals and features of the 5G network to perform or improve the positioning of a device. There also exists a need for further improvements in these positioning protocols and techniques.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus processes a set of reference signal (RS) measurements based on a set of processing parameters to obtain a time-domain channel response associated with the set of RS measurements. The apparatus transmits, to a network entity, the time-domain channel response and an index indicative of the set of processing parameters.

In an aspect of the disclosure, a method, a computer-readable medium, and an apparatus are provided. The apparatus receives, from a user equipment (UE), a time-domain channel response and an index, where the index is indicative of a set of processing parameters for processing a set of RS measurements to obtain the time-domain channel response at the UE. The apparatus performs at least one of: (1) using the index as an additional input for at least one artificial intelligence (AI) or machine learning (ML) (AI/ML) model, (2) selecting, based on the index, one or more AI/ML models from a list of AI/ML models for training or inferencing, or (3) selecting or switching, based on the index, at least one layer in an AI/ML model.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5A is a diagram illustrating an example of direct artificial intelligence (AI)/machine learning (ML) (AI/ML) positioning in accordance with various aspects of the present disclosure.

FIG. 5B is a diagram illustrating an example of AI/ML assisted positioning in accordance with various aspects of the present disclosure.

FIG. 6 is a diagram illustrating an example of different configurations for AI/ML assisted positioning in accordance with various aspects of the present disclosure.

FIG. 7 is a diagram illustrating an example of UE-based positioning with UE-side AI/ML model, direct AI/ML or AI/ML assisted positioning in accordance with various aspects of the present disclosure.

FIG. 8A is a diagram illustrating an example of UE-assisted/location management function (LMF)-based positioning with UE-side AI/ML model, AI/ML assisted positioning in accordance with various aspects of the present disclosure.

FIG. 8B is a diagram illustrating an example of UE-assisted/LMF-based positioning with LMF-side model, direct AI/ML positioning in accordance with various aspects of the present disclosure.

FIG. 9A is a diagram illustrating an example of network node assisted positioning with gNB-side model, AI/ML assisted positioning in accordance with various aspects of the present disclosure.

FIG. 9B is a diagram illustrating an example of network node assisted positioning with LMF-side model, direct AI/ML positioning in accordance with various aspects of the present disclosure.

FIG. 10A is a diagram illustrating an example of time domain sample reporting in accordance with various aspects of the present disclosure.

FIG. 10B is a diagram illustrating an example of time domain sample reporting in accordance with various aspects of the present disclosure.

FIG. 11 is a communication flow illustrating an example procedure of a UE indicating to a location server an indexing and/or brief information related to processing of reference signal (RS) measurements in accordance with various aspects of the present disclosure.

FIG. 12A is a diagram illustrating an example of an LMF-side AI/ML positioning model with UE/transmission reception point (TRP) additional conditions (supported capabilities) on channel response/model input generation in accordance with various aspects of the present disclosure.

FIG. 12B is a diagram illustrating an example of an LMF-side AI/ML positioning model with UE/TRP additional conditions (supported capabilities) on channel response/model input generation in accordance with various aspects of the present disclosure.

FIG. 12C is a diagram illustrating an example of an LMF-side AI/ML positioning model with UE/TRP additional conditions (supported capabilities) on channel response/model input generation in accordance with various aspects of the present disclosure.

FIG. 13 is a communication flow illustrating an example procedure of a base station/TRP indicating to a location server an indexing and/or brief information related to processing of RS measurements in accordance with various aspects of the present disclosure.

FIG. 14 is a flowchart of a method of wireless communication.

FIG. 15 is a flowchart of a method of wireless communication.

FIG. 16 is a diagram illustrating an example of a hardware implementation for an example apparatus and/or network entity.

FIG. 17 is a diagram illustrating an example of a hardware implementation for an example network entity.

FIG. 18 is a flowchart of a method of wireless communication.

FIG. 19 is a flowchart of a method of wireless communication.

FIG. 20 is a diagram illustrating an example of a hardware implementation for an example network entity.

### DETAILED DESCRIPTION

Various aspects relate generally to wireless communication and more particularly to positioning based on wireless communication. Some aspects more specifically relate to improve the overall performance and efficiency for artificial intelligence (AI)/machine learning (ML) (AI/ML) positioning (e.g., on training, inferencing, etc.) by enabling a consistency in reference signal (RS) measurement processing done by entities/nodes (e.g., user equipments (UEs), base stations/transmission reception points (TRPs), etc.) when reporting RS measurements for AI/ML model input. For example, aspects presented herein may enable entities/nodes to rely on a common consistent indexing or brief information related to the RS measurement processing, such that different entities/nodes may be able to know that the same measurement processing configurations/parameters are applied to a set of RS measurements. For example, an entity/node (e.g., a UE, a TRP, etc.) may be configured to identify indexing and/or brief information related to used/supported measurement processing. Then, a location server (e.g., a location management function (LMF)) may use this indexing and/or brief information to ensure a consistency between AI/ML positioning models and the reporting entities/nodes as well as a consistency between training and inference for a given AI/ML positioning model.

Particular aspects of the subject matter described in this disclosure can be implemented to realize one or more of the following potential advantages. Some networks may support an LMF-side direct AI/ML positioning in which a UE is supposed to report measurements of AI/ML model input that is running at the LMF side. The model input options based on time-domain channel response may include time, power, and phase of channel response based on RS (e.g., channel impulse response (CIR)), time and power of channel response based on RS (e.g., power delay profile (PDP)), time of channel response based on RS (e.g., delay profile (DP), first path measurement(s), and/or additional path measurement(s) including power, timing, and/or phase information of measurement(s)). When obtaining time, power, and/or phase information of RS, UE may apply processing of measurements (e.g., oversampling, super resolution, interpolation), which affects the reported timing, power, and phase info. For example, at a given location, when a UE applies different oversampling for obtaining time-domain channel response, the resulting time, power, and phase of channel response can be different. The different time, power, and phase values of channel response for model input may confuse the AI/ML positioning model and reduce positioning accuracy. As presented herein may avoid such problems by (1) ensuring a consistency among UEs from different vendors and/or UEs with different measurement processing implementations, and/or (2) ensuring a consistency between training and inference (e.g., ensure processing of measurements done during data collection and model training is consistent and similar to that considered during inference). For example, aspects presented herein provide signaling mechanisms (e.g., indexing of method used/requested to be used by UE) between UE/LMF to indicate/instruct additional conditions regarding supported/used measurement processing-utilization of signaled additional information by LMF.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

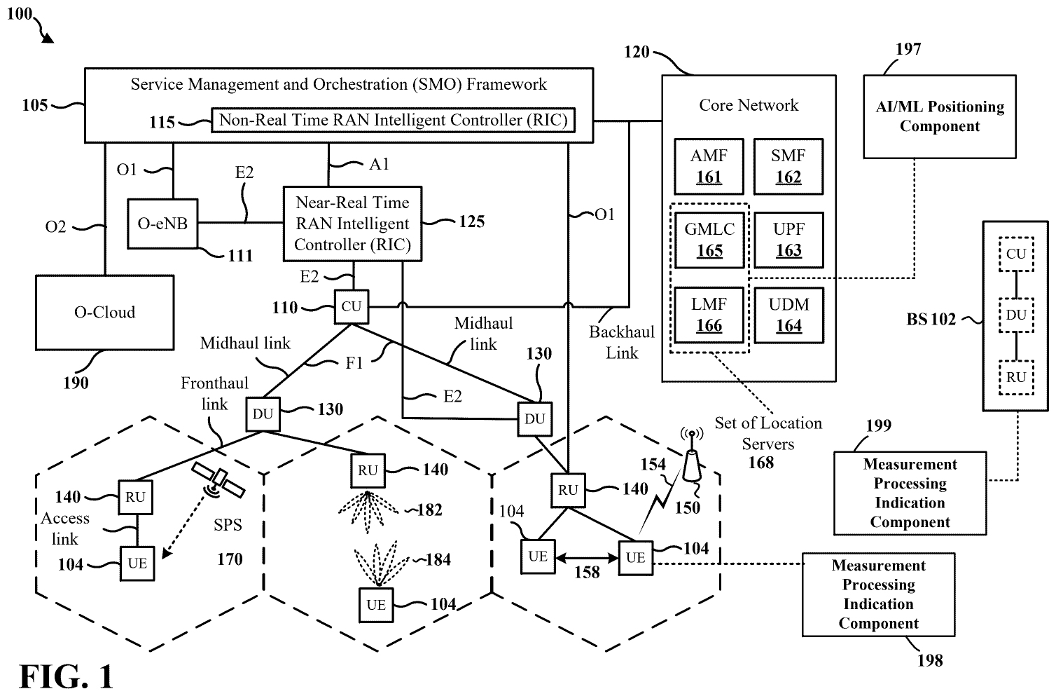

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via dataset collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smartphone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a measurement processing indication component 198 that may be configured to process a set of reference signal (RS) measurements based on a set of processing parameters to obtain a time-domain channel response associated with the set of RS measurements; and transmit, to a network entity, the time-domain channel response and an index indicative of the set of processing parameters. In certain aspects, the base station 102 may have a measurement processing indication component 199 that may be configured process a set of RS measurements based on a set of processing parameters to obtain a time-domain channel response associated with the set of RS measurements; and transmit, to a network entity, the time-domain channel response and an index indicative of the set of processing parameters. In certain aspects, the one or more location servers 168 may have a AI/ML positioning component 197 that may be configured to receive, from a UE, a time-domain channel response and an index, where the index is indicative of a set of processing parameters for processing a set of RS measurements to obtain the time-domain channel response at the UE; and perform at least one of: (1) using the index as an additional input for at least one artificial intelligence (AI) or machine learning (ML) (AI/ML) model, (2) selecting, based on the index, one or more AI/ML models from a list of AI/ML models for training or inferencing, or (3) selecting or switching, based on the index, at least one layer in an AI/ML model.

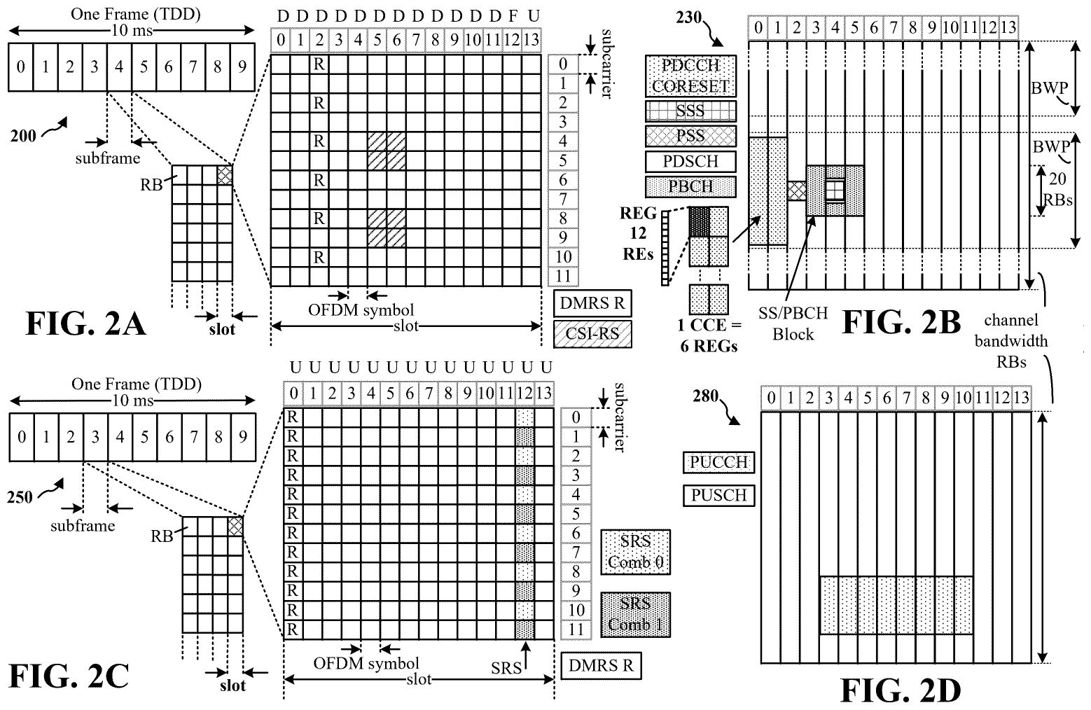

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[KHz] | prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2⁺*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

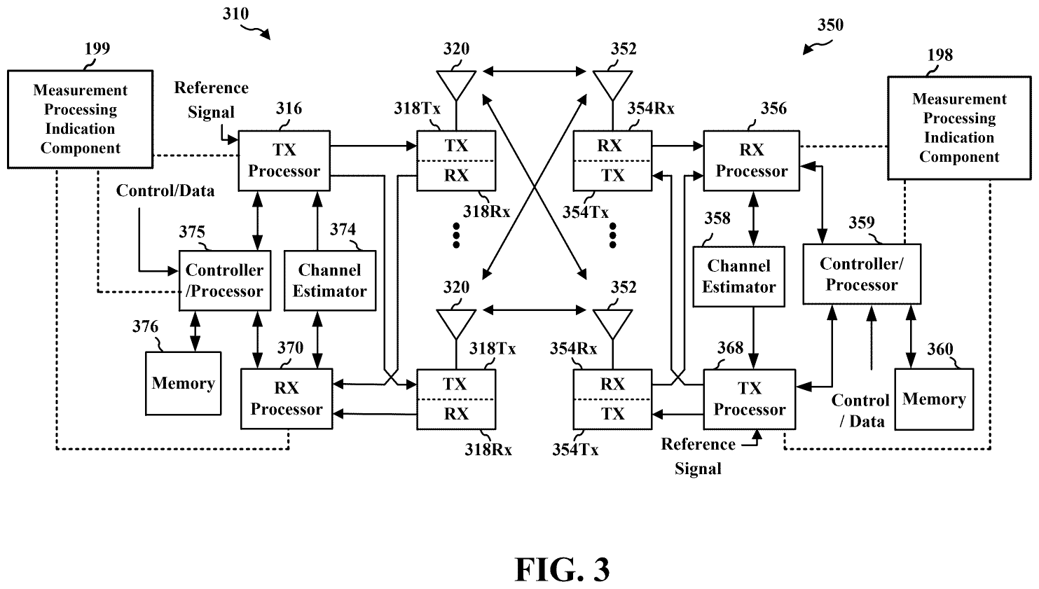

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the measurement processing indication component 198 of FIG. 1.

At least one of the TX processor 316, the RX processor 370, and the controller/processor 375 may be configured to perform aspects in connection with the measurement processing indication component 199 of FIG. 1.

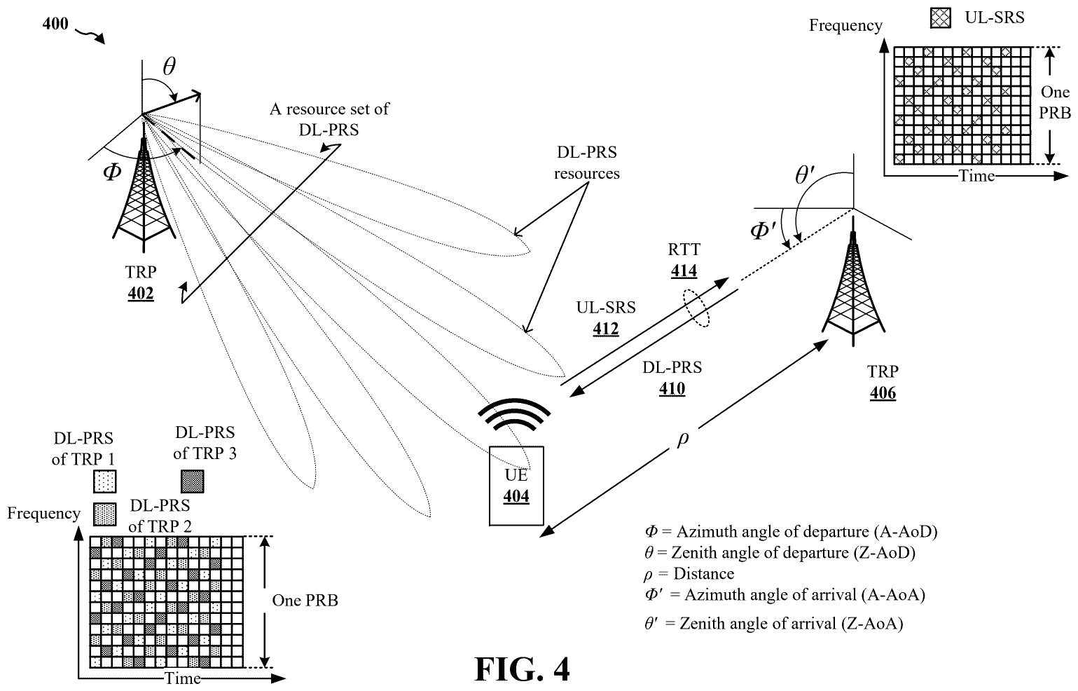

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FRI and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

For purposes of the present disclosure, “UE Rx-Tx time difference” may be defined as T_{UE-RX}−T_{UE-TX}. where: T_{UE-RX} is the UE received timing of downlink subframe #i from a Transmission Point (TP), defined by the first detected path in time. T_{UE-TX} is the UE transmit timing of uplink subframe #j that is closest in time to the subframe #i received from the TP. Multiple DL PRS or CSI-RS for tracking resources, as instructed by higher layers, can be used to determine the start of one subframe of the first arrival path of the TP. For frequency range 1, the reference point for T_{UE-RX} measurement may be the Rx antenna connector of the UE and the reference point for T_{UE-TX} measurement may be the Tx antenna connector of the UE. For frequency range 2, the reference point for T_{UE-RX} measurement may be the Rx antenna of the UE and the reference point for T_{UE-TX} measurement may be the Tx antenna of the UE.

“DL reference signal time difference (DL RSTD)” is the DL relative timing difference between the Transmission Point (TP) j and the reference TP i, defined as T_{SubframeRxj}−T_{SubframeRxi}, where: T_{SubframeRxj} is the time when the UE receives the start of one subframe from TP j. T_{SubframeRxi} is the time when the UE receives the corresponding start of one subframe from TP i that is closest in time to the subframe received from TP j. Multiple DL PRS resources can be used to determine the start of one subframe from a TP. For frequency range 1, the reference point for the DL RSTD may be the antenna connector of the UE. For frequency range 2, the reference point for the DL RSTD may be the antenna of the UE.

“DL PRS reference signal received power (DL PRS-RSRP),” is defined as the linear average over the power contributions (in [W]) of the resource elements that carry DL PRS reference signals configured for RSRP measurements within the considered measurement frequency bandwidth. For frequency range 1, the reference point for the DL PRS-RSRP may be the antenna connector of the UE. For frequency range 2, DL PRS-RSRP may be measured based on the combined signal from antenna elements corresponding to a given receiver branch. For frequency range 1 and 2, if receiver diversity is in use by the UE, the reported DL PRS-RSRP value may not be lower than the corresponding DL PRS-RSRP of any of the individual receiver branches.

“DL PRS reference signal received path power (DL PRS-RSRPP),” is defined as the power of the linear average of the channel response at the i-th path delay of the resource elements that carry DL PRS signal configured for the measurement, where DL PRS-RSRPP for the 1st path delay is the power contribution corresponding to the first detected path in time. For frequency range 1, the reference point for the DL PRS-RSRPP may be the antenna connector of the UE. For frequency range 2, DL PRS-RSRPP may be measured based on the combined signal from antenna elements corresponding to a given receiver branch. For frequency range 1 and 2, if receiver diversity is in use by the UE for DL PRS-RSRPP measurements, the reported DL PRS-RSRPP value included in the higher layer parameter NR-DL-AoD-MeasElement for the first and additional measurements may be provided for the same receiver branch(es) as applied for DL PRS-RSRP measurements.

“DL reference signal carrier phase (RSCP)” is defined as the phase of the channel response at the 1st path delay derived from the resource elements carrying DL PRS configured for the measurement. DL RSCP is associated with the center frequency of the DL positioning frequency layer (PFL) configured for the measurement for RRC connected, RRC inactive, and RRC idle modes. For frequency range 1, the reference point for the DL RSCP may be the antenna connector of the UE. For frequency range 2, the reference point for the DL RSCP may be the antenna of the UE.

“DL reference signal carrier phase difference (RSCPD)” is defined as the difference of DL RSCPs measured from DL PRS transmitted in a DL PFL from the transmission point (TP) j and the reference TP i. If UE reports RSCPD measurements together with RSTD measurements in a measurement report element, the reference TP for RSCPD is the same as the reference TP reported for RSTD. For frequency range 1, the reference point for the DL RSCPD may be the antenna connector of the UE. For frequency range 2, the reference point for the DL RSCPD may be the antenna of the UE.

In some implementations, at least one artificial intelligence (AI)/machine learning (ML) (AI/ML) model may be configured/implemented at an entity/node (e.g., a UE, a network entity/node such as a base station, a location server, a location management function (LMF), etc.) for assisting the entity/node with the positioning of a UE. For example, an AI/ML model may be trained to determine the position of a UE based on DL-AoA, DL-TDOA, channel impulse response (CIR), radio frequency (RF) fingerprinting, etc. In most scenarios, using an AI/ML model may significantly improve UE positioning latency, accuracy/reliability, and/or efficiency. For purposes of the present disclosure, an AI/ML model that is implemented at a UE side may be referred to as a “UE-side model” and/or “UE-side AI/ML model.” On the other hand, an AI/ML model that is implemented at a network side may be referred to as a “network-side model,” “network-side AI/ML model,” and/or (network name)-side AI/ML model (e.g., base station-side AI/ML model, LMF-side AI/ML model, etc.).

In addition, positioning that is associated with a UE or a network entity/node using an AI/ML model to determine the position of the UE may be referred to as “direct AI/ML positioning,” whereas positioning that is associated with a UE or a network entity/node performing positioning related measurements using an AI/ML model (and transmitting the positioning related measurements to another entity) to determine the position of the UE may be referred to as “AI/ML assisted positioning” and/or “assisted AI/ML positioning.” Also, UE-based positioning (e.g., UE determines its own position) using at least one UE-side AI/ML model may be referred to as “direct UE AI/ML positioning” and/or “UE direct AI/ML positioning,” whereas UE-assisted positioning (e.g., a UE provides positioning measurements and a network entity, such as an LMF, determines the position for the UE based on the positioning measurements provided by the UE) using at least one UE-side AI/ML model may be referred to as “UE AI/ML assisted positioning,” “UE assisted AI/ML positioning” “AI/ML assisted UE positioning,” and/or “AI/ML UE assisted positioning,” etc. Similarly, network-based positioning (e.g., a network entity, such as an LMF, determines the position for the UE) using at least one network/LMF-side AI/ML model may be referred to as “direct network/LMF AI/ML positioning” and/or “network/LMF direct AI/ML positioning.”

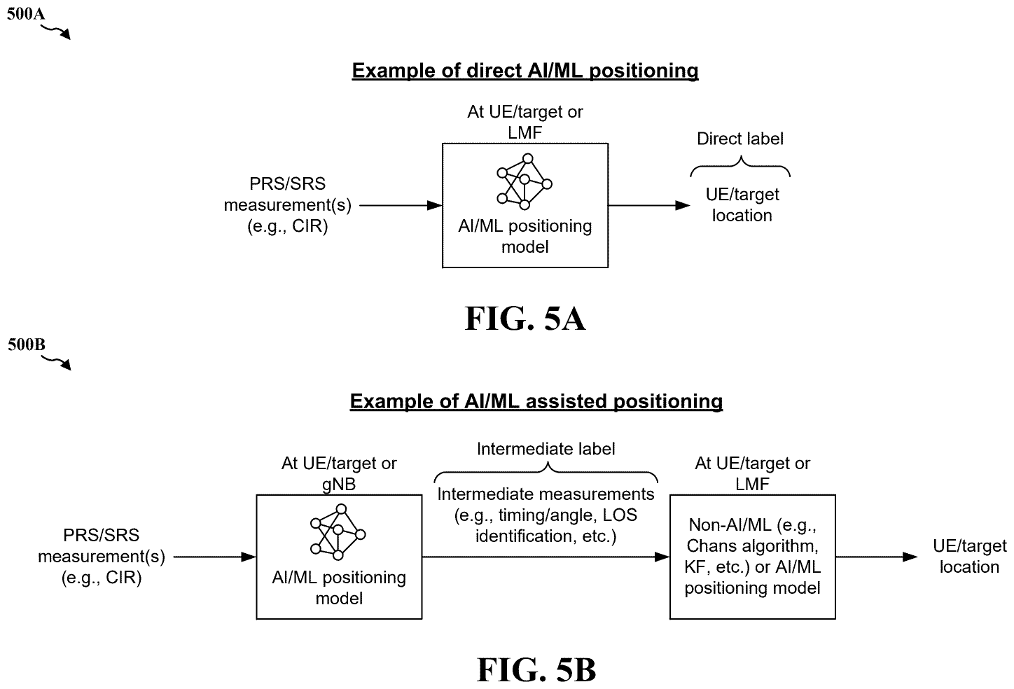

FIG. 5A is a diagram 500A illustrating an example of direct AI/ML positioning in accordance with various aspects of the present disclosure. For direct AI/ML positioning, an entity/node (e.g., a UE, a network entity/node such as a base station, a location server, etc.) may use at least one AI/ML model to determine the position of a UE or a target. For example, a UE may receive and measure PRSs transmitted from one or more base stations, and the UE may determine its position using an AI/ML model based on the PRS measurements. In another example, an LMF may receive PRS measurements from a UE or SRS measurements from a baes station, and the LMF may determine the position of the UE using an AI/ML model based on the PRS/SRS measurements.

FIG. 5B is a diagram 500B illustrating an example of AI/ML assisted positioning in accordance with various aspects of the present disclosure. For AI/ML assisted positioning, an entity/node (e.g., a UE, a network entity/node such as a base station, etc.) may use at least one AI/ML model to assist the measurement of reference signals (e.g., positioning reference signals such as PRS, SRS, etc.). Then, the entity/node may transmit the reference signal measurements to a location server, such as an LMF. In response, the location server may determine the position of the UE based on a non-AI/ML mechanism/algorithm, or based on using an AI/ML model to determine the position of the UE. For example, a UE may receive and measure PRSs transmitted from one or more base stations, and the UE may transmit the PRS measurements to an LMF. The PRS measurements may include intermediate measurements, such as timing and/or angle of the PRSs, whether the PRSs are received based on a line-of-sight (LOS) condition or a non-line-of-sight (NLOS) condition, etc. Then, the LMF may determine the position of the UE based on the PRS measurements (e.g., the intermediate measurements) with or without using an AI/ML model. Similarly, a base station may receive and measure SRSs transmitted from a UE, and the bacs station may transmit the SRS measurements to an LMF. Then, the LMF may determine the position of the UE based on the SRS measurements (e.g., the intermediate measurements) with or without using an AI/ML model.

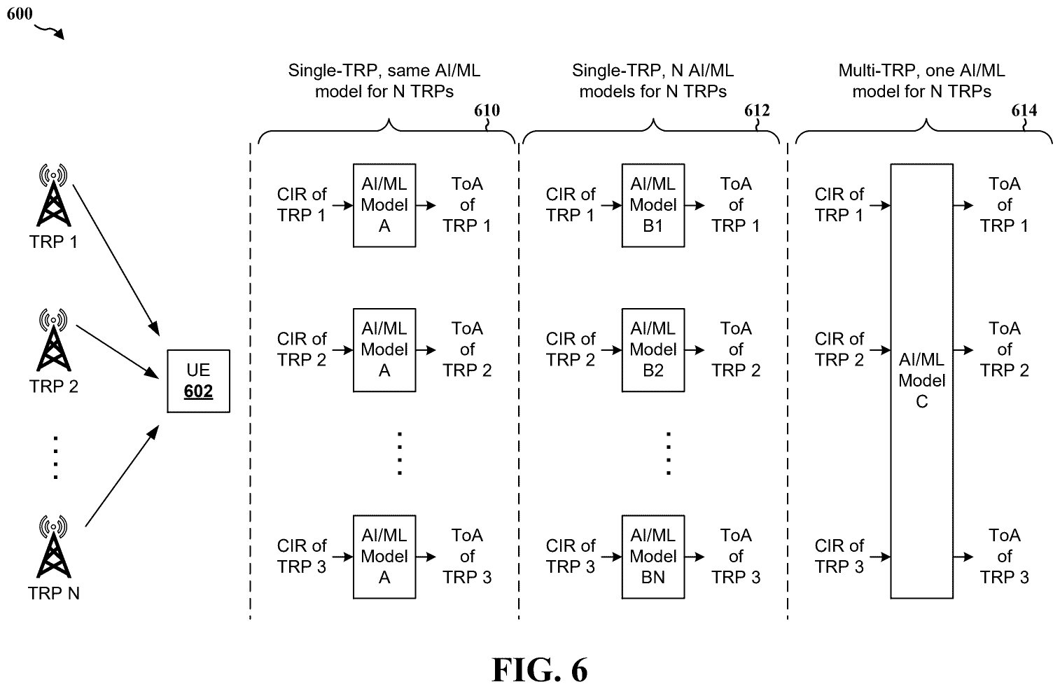

FIG. 6 is a diagram 600 illustrating an example of different configurations for AI/ML assisted positioning in accordance with various aspects of the present disclosure. In one example, as shown at 610, for AI/ML assisted positioning, a same AI/ML model may be used for multiple TRPs, where one AI/ML model may be configured for each TRP (referring to as a “single-TRP” setting). For example, a UE 602 may receive a set of positioning reference signals from N TRPs (e.g., from a first TRP, a second TRP, . . . , and up to an N^{th} TRP), and measure the channel impulse response (CIR) for the set of positioning reference signals from each TRP. Then, the UE 602 may input the measured CIR for each TRP to an AI/ML model (e.g., AI/ML Model A) configured for/associated with each TRP, where the AI/ML model may infer the time of arrival (ToA) of the positioning reference signal for the corresponding TRP based on the corresponding CIR. In other words, CIR of the first TRP is input to an AI/ML model A associated with the first TRP, CIR of the second TRP is input to an AI/ML model A associated with the second TRP, and CIR of the N^{th} TRP is input to an AI/ML model A associated with the N^{th} TRP, etc.

In another example, as shown at 612, different AI/ML models may be used for multiple TRPs, where one AI/ML model may be configured for each TRP (e.g., also the “single-TRP” setting but each TRP may use a different AI/ML model). For example, CIR of the first TRP may be input to a first AI/ML model (e.g., AI/ML Model B1) for inferring the ToA of the first TRP, CIR of the second TRP may be input to a second AI/ML model (e.g., AI/ML Model B2 that is different from AI/ML Model B1) for inferring the ToA of the second TRP, and CIR of the N^{th} TRP may be input to an N^{th} AI/ML model (e.g., AI/ML Model B_{N} that is different from AI/ML Model B₁ and AI/ML Model B₂) for inferring the ToA of the AI/ML Model B1 TRP, etc.

In another example, as shown at 614, one AI/ML model may be used for multiple TRPs (referring to as a “multi-TRP” setting). For example, CIRs from the N TRPs may be input to one AI/ML model (e.g., AI/ML Model C), and the AI/ML model may infer the ToA for each TRP. For AI/ML assisted positioning, different model input realizations may have different implications on accuracy, generalization, robustness, as well as model complexity and life cycle management (LCM).

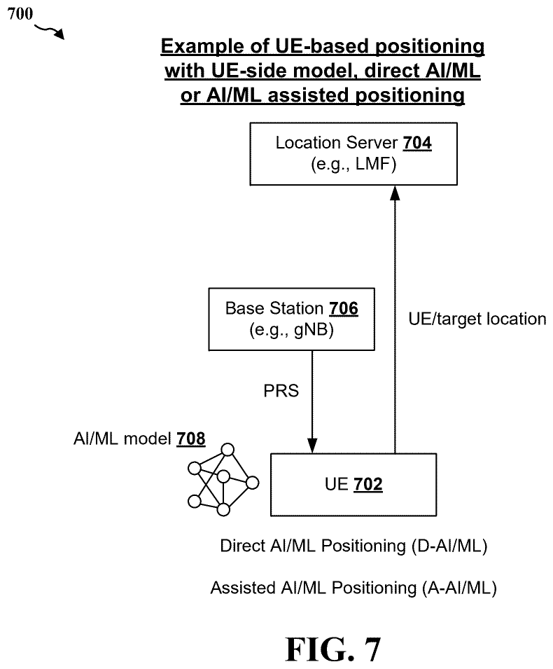

FIG. 7 is a diagram 700 illustrating an example of UE-based positioning with UE-side AI/ML model, direct AI/ML or AI/ML assisted positioning in accordance with various aspects of the present disclosure. In one implementation, a UE 702 may be associated with at least one AI/ML model 708, and the UE 702 may use the at least one AI/ML model 708 to perform the direct AI/ML positioning and/or the assisted AI/ML positioning based on downlink (DL) reference signals, such as positioning reference signals (PRSs). For example, the UE 702 may receive and measure a set of PRSs transmitted from a base station 706, such as measuring the reference signal received power (RSRP), channel impulse response (CIR), DL-AOD, reference signal time difference (RSTD), time of arrival (ToA), and/or time of flight (ToF) of the set of PRSs, etc., which may be collectively be referred to as “PRS measurement(s)” and/or “PRS-based measurement(s).” In some examples, the UE 702 may use the at least one AI/ML model 708 for measuring the set of PRSs (e.g., for assisted AI/ML positioning). In some examples, based on the PRS measurement(s), the UE 702 may use the at least one AI/ML model 708 for determining its position (e.g., for direct AI/ML positioning). Note in this assisted AI/ML positioning example, the UE 702 may use the at least one AI/ML model 708 for performing PRS measurements, and the UE 702 may determine its position based on the PRS measurements without the assistance of an AI/ML model.

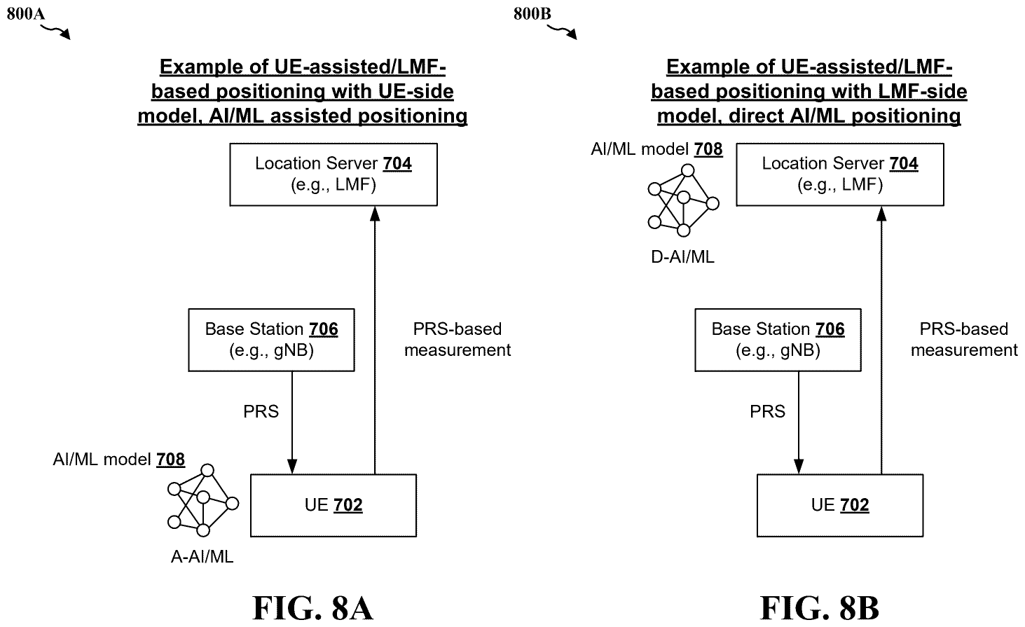

FIG. 8A is a diagram 800A illustrating an example of UE-assisted/LMF-based positioning with UE-side AI/ML model, AI/ML assisted positioning in accordance with various aspects of the present disclosure. In another implementation, a UE 702 may be associated with at least one AI/ML model 708, and the UE 702 may use the at least one AI/ML model 708 to perform or assist measurement(s) of DL reference signals. For example, the UE 702 may receive and measure a set of PRSs transmitted from a base station 706 with the assistance of the at least one AI/ML model 708, which may be referred to as “PRS-based measurement(s).” Then, the UE 702 may transmit the PRS-based measurement(s) to a location server 704, such as an LMF. In response, the location server 704 may determine the position of the UE 702 based on the PRS-based measurement(s) (with or without suing an AI/ML model).

FIG. 8B is a diagram 800B illustrating an example of UE-assisted/LMF-based positioning with LMF-side AI/ML model, direct AI/ML positioning in accordance with various aspects of the present disclosure. In another implementation, a UE 702 may not include a UE-side AI/ML model, and a location server 704 may use at least one AI/ML model 708 to determine the position of the UE 702. For example, the UE 702 may receive and measure a set of PRSs transmitted from a base station 706, and the UE 702 may transmit the PRS-based measurement(s) to the location server 704, such as an LMF. In response, the location server 704 may use the at least one AI/ML model 708 to determine the position of the UE 702 based on the PRS-based measurement(s) from the UE 702.

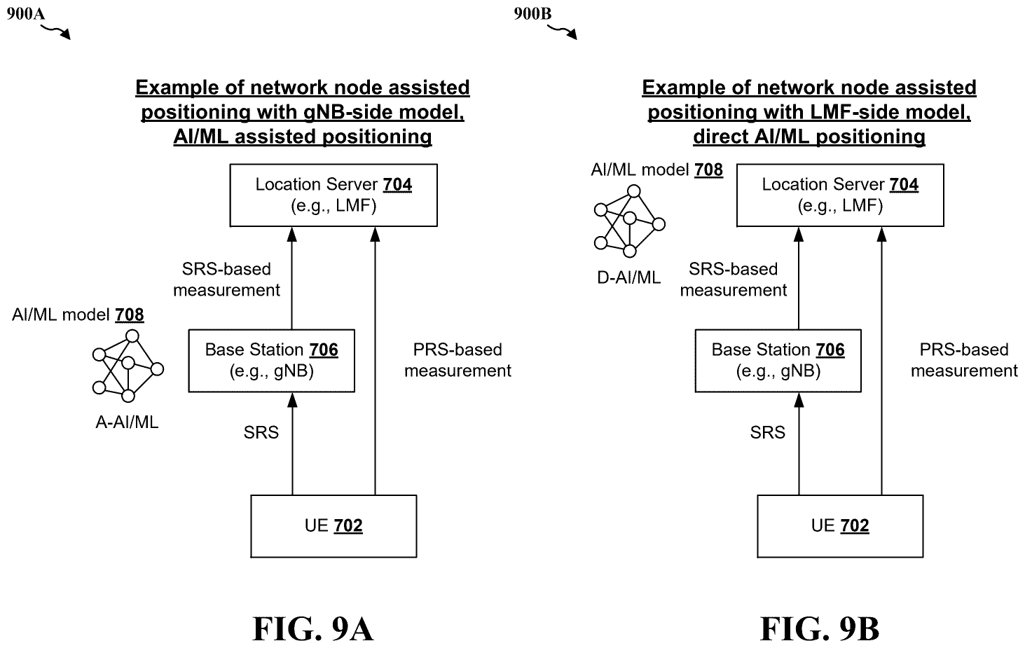

FIG. 9A is a diagram 900A illustrating an example of network (e.g., NG-RAN) node assisted positioning with gNB-side AI/ML model, AI/ML assisted positioning in accordance with various aspects of the present disclosure. In another implementation, a network node, such as a base station 706, may be associated with at least one AI/ML model 708, and the base station 706 may use the at least one AI/ML model 708 to assist measurement(s) of uplink (UL) reference signals, such as sounding reference signals (SRSs). For example, the UE 702 may transmit a set of SRSs to the base station 706, and the base station 706 may receive and measure the set of SRSs (which may be referred to as “SRS-based measurement(s)”) with the assistance of the at least one AI/ML model 708. Then, the base station 706 may transmit the SRS-based measurement(s) to the location server 704, such as an LMF. In response, the location server 704 may determine the position of the UE 702 based on the SRS-based measurement(s) from the base station 706 (with or without suing an AI/ML model).

FIG. 9B is a diagram 900B illustrating an example of network (e.g., NG-RAN) node assisted positioning with LMF-side AI/ML model, direct AI/ML positioning in accordance with various aspects of the present disclosure. In another implementation, a network node, such as a base station 706, may not include an AI/ML model, and a location server 704 may use at least one AI/ML model 708 to determine the position of a UE 702. For example, the UE 702 may transmit a set of SRSs to the base station 706, and the base station 706 may receive and measure the set of SRSs. Then, the base station 706 may transmit the SRS-based measurement(s) to the location server 704, such as an LMF. Based on the SRS-based measurement(s) from the base station 706, the location server 704 may use the at least one AI/ML model 708 to determine the position of the UE 702. For purposes of the present disclosure, positioning described in connection with FIGS. 7, 8A, and 8B may be referred to as AI/ML positioning based on DL reference signals, and positioning described in connection with FIGS. 9A and 9B may be referred to as AI/ML positioning based on UL reference signals.

Table 2 below provides an example list of UE positioning methods that may be supported by a network.

TABLE 2
Supported UE Positioning Method

| | | UE- | NG-RAN |
|---|---|---|---|
| | UE- | assisted, | node |
| Method | based | LMF-based | assisted |
| A-GNSS (Assisted-Global | Yes | Yes | No |
| Navigation Satellite System) | | | |
| OTDOA (Observed Time | No | Yes | No |
| Difference of Arrival) | | | |
| E-CID (Enhanced Cell ID) | No | Yes | Yes |
| Sensor | Yes | Yes | No |
| WLAN (Wireless Local- | Yes | Yes | No |
| Area Network) | | | |
| Bluetooth | Yes | Yes | No |
| TBS (Terrestrial Beacon | Yes | Yes | No |
| System) | | | |
| DL-TDOA (Downlink-Time | Yes | Yes | No |
| Difference of Arrival) | | | |
| DL-AoD (Downlink-Angle | Yes | Yes | No |
| of Departure) | | | |
| Multi-RTT (Multi-Roundtrip | No | Yes | Yes |
| Time) | | | |
| NR E-CID | No | Yes | Yes |
| UL-TDOA (Uplink-Time | No | No | Yes |
| Difference of Arrival) | | | |
| UL-AoA (Uplink-Angle of | No | No | Yes |
| Arrival) | | | |

In some implementations, for direct AI/ML positioning as described in connection with FIGS. 8B and 9B, type(s) of measurement(s) that may be used as (suitable/potential) input for AI/ML model inference considering performance impact and associated signaling overhead may include channel impulse response (CIR), power delay profile (PDP), reference signal receive power (RSRP), reference signal received path power (RSRPP), and/or reference signal time difference (RSTD), etc. For AI/ML assisted positioning with UE-assisted and network node-assisted positioning described in connection with FIGS. 8A and 9A, respectively, measurement report to carry AI/ML model (suitable/potential) output to a location server such as an LMF may include ToA, path phase, RSTD, line-of-sight (LOS)/non-line-of-sight (NLOS) indicator, RSRPP, and/or soft information/high resolution of RSTD, etc. In some examples, AI/ML model inference output that may provide performance benefits may include timing estimation (note the report to LMF may be derived based on and maybe different from the model inference output) and/or LOS/NLOS indicator.

In some studies, for the evaluation of AI/ML based positioning with multipath measurement for model input and for a given set of parameters (N′_{TRP}, Nₜ, N′ₜ, Nₚₒᵣₜ), CIR appears to have the largest measurement size, where CIR is composed of a list of measurements where each measurement contains the information of: (a) delay, (b) power and (c) phase. PDP appears to have smaller measurement size compared to CIR, where PDP is composed of a list of measurements where each measurement contains the information of: (a) delay and (b) power. Delay profile (DP) appears to have the smallest measurement size (compared to both CIR and PDP), where DP is composed of a list of measurements where each measurement contains the information of: (a) delay.

In one example, for reporting the AI/ML model input dimension N_{TRP}*Nₚₒᵣₜ*Nₜ of CIR and PDP, where Nₜ may refer to the first Nₜ consecutive time domain samples, if N′ₜ (N′ₜ<Nₜ) samples with the strongest power are selected as AI/ML model input, with remaining (Nₜ−N′ₜ) time domain samples set to zero, then a wireless device (e.g., a UE, a base station, a TRP, etc.) may be configured to report value N′ₜ in addition to Nₜ. It may also be assumed that timing information for the N′ₜ samples are provided as the AI/ML model input. For purposes of the present disclosure, Nₜ may refer to the number of consecutive samples (CIR/PDP) (e.g., size of a truncation window), N′ₜ<Nₜ may refer to the number of subsampling (CIR/PDP) within Nₜ, Nₚₒᵣₜ may refer to the number of ports (i.e., number of antennas) per TRP, and N_{TRP} may refer to the number of TRPs.

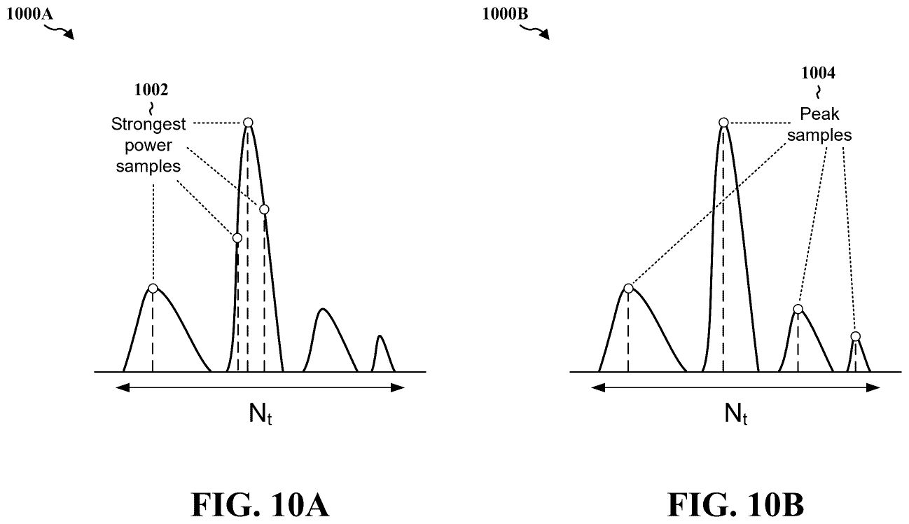

FIG. 10A is a diagram 1000A illustrating an example of time domain sample reporting in accordance with various aspects of the present disclosure. In some configurations, as shown at 1002, to report time domain samples (e.g., associated with measurements such as CIR, PDP, and/or DP, etc.), an entity/node (e.g., a UE, a network entity/node such as a base station/TRP, etc.) may be configured to report a defined number (N′ₜ) of strongest power samples in a number of consecutive samples (Nₜ). For example, for evaluation of AI/ML based positioning, when time domain samples are used as AI/ML model input and sub-sampling is applied, the selection of N′ₜ measurements may be based on the strongest power. However, when sub-sampling is applied, the N′ₜ measurement may not necessarily be consecutive in time. Training dataset and test dataset for an AI/ML model may use the same measurement selection method (e.g., strongest power).

FIG. 10B is a diagram 1000B illustrating an example of time domain sample reporting in accordance with various aspects of the present disclosure. In some configurations, as shown at 1004, to report time domain samples (e.g., associated with measurements such as CIR, PDP, DP, first path measurements, and/or additional path measurements including power, timing, and/or phase information of measurement etc.), an entity/node (e.g., a UE, a network entity/node such as a base station/TRP, etc.) may be configured to report a defined number (N′ₜ) of peak samples in a number of consecutive samples (Nₜ) instead of strongest power samples.

In some configurations, for direct AI/ML positioning with location server/LMF-side model as described in connection with FIGS. 8B and 9B, the following types of measurement reports may be used for AI/ML based positioning accuracy enhancement. The first type of measurement report may contain timing, power, and phase information of the channel response. If such measurement report is supported, the measurement report may be specified to include information related to truncation, feature extraction, and/or alignment of sample/path determination, etc. The second type of measurement report may contain timing and power information of the channel response. If such measurement report is supported, the measurement report may also be specified to include information related to truncation, feature extraction, and/or alignment of sample/path determination, etc. The third type of measurement report may contain just timing information of the channel response. If such measurement report is supported, the measurement report maybe specified to include information related to alignment of sample/path determination.

CIR, PDP, and DP may be obtained/derived using a variety of methods. In one example, an entity/node (e.g., a UE, a network entity/node such as a base station/TRP, etc.) may be configured to obtain channel frequency response (CFR) first, such as by applying a channel estimation in a frequency domain based on a reference signal (e.g., PRS) sequence mapped to an orthogonal frequency-division multiplexing (OFDM) signal(s). Then, the entity/node may obtain the CIR based on the CFR, such as by applying inverse Fourier transform (ifft) to the CFR (e.g., CIR=ifft(CFR)). In some configurations, the entity/node may optionally be configured to apply a truncation to CIR (e.g., CIR_trunc). Truncation may refer to a process of reducing the size of a CIR by removing/cutting (e.g., truncating) at least a portion/part of the CIR. In some examples, CIR may also correspond to a plurality of time, power, and/or phase information that are derived from output of ifft(CFR).

An entity/node may obtain the PDP based on the absolute value of the CIR (e.g., abs (CIR)), or the PDP may correspond to a plurality of time and power information that are derived from CIR. Similarly, in some configurations, the entity/node may optionally be configured to apply a truncation to PDP (e.g., PDP_trunc). On the other hand, a DP may correspond to timing information of CIR/PDP measurements with (significant) power/peak information, or may correspond to a plurality of time information that are derived from CIR/PDP. Similarly, in some configurations, the entity/node may optionally be configured to apply a truncation to DP (e.g., DP_trunc).

AI/ML positioning (both direct and assisted) has been shown to provide high positioning accuracy in stringent NLOS conditions. As described in connection with FIGS. 8B and 9B, some networks have supported an LMF-side direct AI/ML positioning in which a UE/base station/TRP (collectively as an “entity/node”) may be configured to report measurements of AI/ML model input running at the LMF side, where the AI/ML model input options may be based on one of following time-domain channel response: (1) CIR-time, power, and phase of channel response based on reference signal (RS) (e.g., PRS, SRS, etc.), (2) PDP-time and power of channel response based on (RS) (e.g., PRS, SRS, etc.), and/or (3) DP-time of channel response based on (RS) (e.g., PRS, SRS, etc.).

In some scenarios, when obtaining time, power, and/or phase information of RS, an entity/node may apply one or more processing techniques to the RS measurements (e.g., oversampling, super resolution, and/or interpolation, etc.), which may affect the reported timing, power, and/or phase information. For example, at a same location, when a UE applies different oversampling for obtaining time-domain channel responses, the resulting time, power, and phase of the obtained channel responses may be different. However, the difference in time, power, and/or phase values of channel response for AI/ML model input may confuse the AI/ML positioning model(s) and reduce positioning accuracy. As such, it may be important for a network to ensure that there is an alignment on processing of measurements used as AI/ML model input. For examples, it may be important for the network to ensure that there is a consistency among UEs from different vendors and/or UEs with different measurement processing implementations, and/or ensure that there is a consistency between training and inference (e.g., ensure the processing of measurements is done during data collection and model training is consistent and similar to that during inference). One possible solution to enable such consistency and alignment is to enforce the procedure of the measurement processing (e.g., an entity/node is configured to follow/apply a set of specified CIR/PDP/DP measurement processing procedures or parameters). While this solution may be useful in addressing the problem, it may not be suitable in many scenarios because measurement processing may be an implementation that is left for the entity/node designer and vendor. In addition, specifying measurement processing may limit the competency and innovation in measurement processing among entity/node designers and vendors. Another possible solution to enable such consistency and alignment is to request the entities/nodes to disclose their (supported) measurement processing details. However, this may not be suitable due to concerns on disclosing confidential implementation details.

Aspects presented herein may improve the overall performance and efficiency for AI/ML positioning (e.g., on training and inferencing) by enabling a consistency in measurement processing done by entities/nodes (e.g., UEs, base stations/TRPs, etc.) when reporting RS measurements for AI/ML model input. For example, aspects presented herein may enable entities/nodes to rely on a common consistent indexing or brief information related to the measurement processing, such that different entities/nodes may be able to know that the same measurement processing configurations/parameters are applied to a set of measurements (e.g., performed by one of the entities/nodes). For example, an entity/node (e.g., a UE, a TRP, etc.) may be configured to identify indexing and/or brief information related to used/supported measurement processing. Then, a location server (e.g., an LMF) may use this indexing and/or brief information to ensure a consistency between AI/ML positioning models and the reporting entities/nodes as well as a consistency between training and inference for a given AI/ML positioning model. As certain entities/nodes, such as UEs, may come from just a handful number of vendors/chip vendors, the potential list of indices indicating the measurement processing may not be too large (e.g., is likely manageable by the network). Aspects presented herein also provide signaling for an entity/node (e.g., a UE, a base station/TRP, etc.) to indicate (assistance) additional conditions to a location server (e.g., an LMF) regarding supported/used measurement processing.

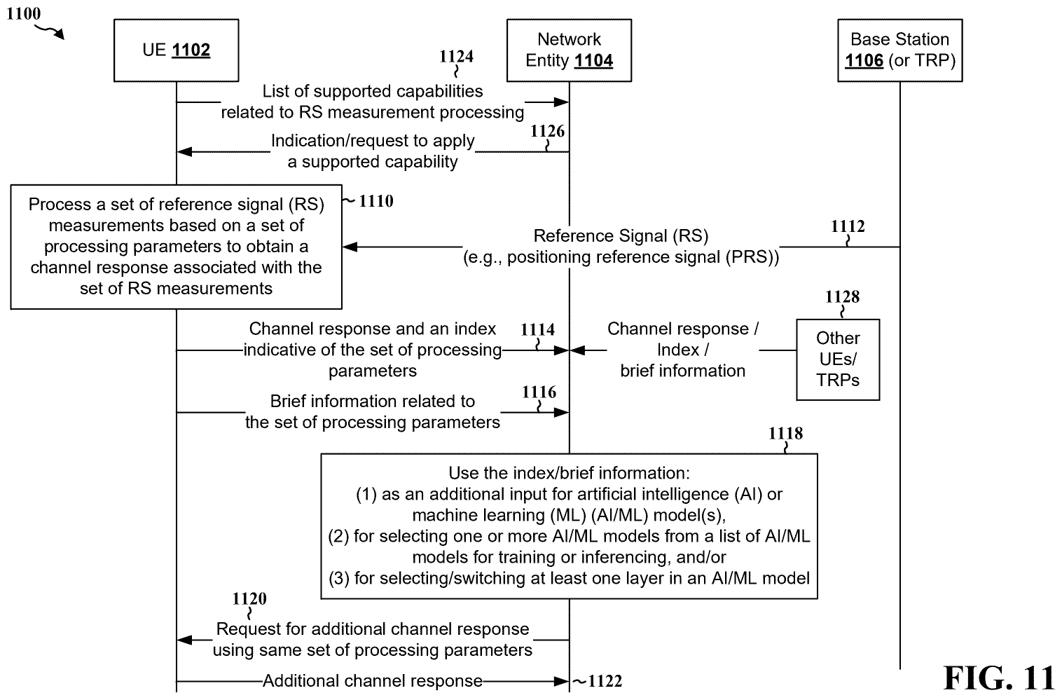

FIG. 11 is a communication flow 1100 illustrating an example procedure of a UE indicating to a location server an indexing and/or brief information related to processing of RS measurements in accordance with various aspects of the present disclosure. The numberings associated with the communication flow 1100 do not specify a particular temporal order and are merely used as references for the communication flow 1100. Note while the communication flow 1100 is illustrated with a UE, aspects presented herein may also apply to other entities/nodes, such as to a positioning reference units (PRU) or a TRP, etc.

At 1110, a UE 1102 may be configured to measure a set of reference signals (RS) to obtain a set of RS measurements, and process the set of RS measurements using at least one RS measurement processing technique (e.g., oversampling, super resolution, interpolation, etc.) (collectively as “a set of processing parameters”) to obtain a channel response associated with the set of RS measurements. As shown at 1112, the set of RS may be a set of positioning reference signals (PRS) transmitted from a base station 1106 (or its TRP(s)). As discussed above, the channel response may be a time-domain channel response, such as a CIR, a PDP, a DP, first path measurement(s), additional path measurement(s) (e.g., may include power, timing, and/or phase information of measurement), or a combination thereof. In some examples, the channel response may also be a time-domain channel response such as a CFR.

At 1114, based on the obtained channel response, the UE 1102 may transmit, to a network entity 1104 (e.g., a server, a location server, an LMF, etc.), the channel response and an index (or indexing) indicative of the set of processing parameters. In one example, different indices may correspond to different sets of processing parameters. For example, a first index (index #1) may correspond to an oversampling processing technique with a first set of oversampling parameters, a second index (index #2) may correspond to an oversampling processing technique with a second set of oversampling parameters, and a third index (index #3) may correspond to an interpolation processing technique with a set of interpolation parameters, etc. In some examples, the index may be considered as an additional condition of the UE 1102 for supporting AI/ML positioning models running at a network side (e.g., an LMF side). The UE 1102 may be configured to freely select different indices for different processing parameters as long as the UE 1102 is able to keep it consistent overtime. For example, if the UE 1102 selects the first index to indicate an oversampling processing technique with a specific set of oversampling parameters, the UE 1102 is expected to use the same index whenever the UE 1102 applies the same oversampling processing technique with the same specific set of oversampling parameters to RS measurement(s).

In some implementations, as shown at 1116, the UE 1102 may also transmit, to the network entity 1104, brief information related the set of processing parameters. The brief information may be some high-level information related to the RS processing techniques and/or their parameters. In one configuration, the brief information may be configured to be non-proprietary or non-confidential information (e.g., the set of processing parameters may be related to proprietary or confidential information, but the index/brief information may be related to non-proprietary or non-confidential information). For example, the brief information may be a sampling rate for the processing of the set of RS measurements, a sampling period for the processing of the set of RS measurements, an indication of whether the sampling period is consistent with an RS bandwidth and subcarrier spacing (SCS), and/or an indication of whether a reported channel response is aligned with a sampling grid or is off-grid, etc. Note while the communication flow 1100 shows the UE 1102 transmits the channel response/index and the brief information via different signaling, it is merely for illustration purposes. In some examples, the brief information may be transmitted with the channel response and the index, or the brief information may be optional or skipped.

In some examples, the transmission/application of the index/brief information related to the RS measurement processing by the UE 1102 may be based on an indication from the network entity 1104 that the channel response is going to be used for AI/ML positioning related operation(s). For example, prior to the UE 1102 processes the set of RS measurements at 1110, the network entity 1104 may transmit an indication (not shown in the communication flow 1100) to the UE 1102 that the channel responses from the UE 1102 are going to be used for AI/ML positioning related operation(s) (e.g., for data collection, AI/ML model training, AI/ML model inferencing, etc.). Then, based on the indication, the UE 1102 may include the index/brief information corresponding to the RS measurement processing performed by the UE 1102 as described above. However, if the network entity 1104 does not transmit the indication, then the UE 1102 may just report the channel response without the index/brief information to reduce the signaling overhead.

At 1118, based on the channel response, the index, and/or the brief information, the network entity 1104 may be configured to use the index/brief information as an additional input for AI/ML model(s), use the index/brief information to select one or more AI/ML models from a list of AI/ML models for training and/or inferencing, and/or (3) use the index/brief information to select and/or switch at least one layer in an AI/ML model, etc.

In some examples, the network entity 1104 may request the UE 1102 to apply one or more of RS measurement processing methods supported by the UE 1102 by indicating the indexing and/or the brief information. For example, as shown at 1120, after the network entity 1104 learns the index and/or the brief information associated with a channel response (e.g., at 1114 and 1116), if the network entity 1104 would like to request the UE 1102 to provide additional channel response(s) using the same set of processing parameters (e.g., using the same RS measurement processing technique(s) or parameter(s) as 1110), the network entity 1104 may make the request using the learned index and/or the brief information. At 1122, in response to the request, the UE 1102 may process another set of RS using the same set of processing parameters (associated with the index/brief information) to obtain additional channel response(s), and the UE 1102 may transmit the additional channel response(s) to the network entity 1104. Such configuration may enable the network entity 1104 to obtain additional channel response(s) with consistent RS measurement processing techniques/parameters without knowing the specifics of the processing techniques/parameters (which may be confidential/proprietary to the UE vendor).

In another example, as shown at 1124, the UE 1102 may be configured to transmit, to the network entity 1104, a list of capabilities related to RS measurement processing supported by the UE 1102 for obtaining channel responses. Depending on implementations, the capabilities may also be referred to as “additional conditions” and/or “supported capabilities.” In one example, the UE 1102 may transmit the list of capabilities to the network entity 1104 using the LTE positioning protocol (LPP), such as via a capability message/messaging and/or a provide location message/messaging. At 1126, based on the list of capabilities supported by the UE 1102, the network entity 1104 may indicate/request the UE 1102 to apply at least one of the capabilities for processing the RS measurements. Similarly, the network entity 1104 may transmit the indication/request to the UE 1102 using the LPP, such as via a request location message/messaging.

In other word, an enhanced, dedicated, or new LPP signaling from a UE to an LMF may be configured in which the UE may indicate its supported additional conditions (i.e., capabilities) related to processing the UE does to obtain the time-domain channel response when reported to the LMF and used for input of an LMF-side AI/ML positioning model. The reporting of this enhanced, dedicated, or new signaling may happen as part of provide location messaging. There may also be an enhanced, dedicated, or new LPP signaling from the UE to the LMF in which the UE may indicate its additional conditions related to the processing that the UE does to obtain time-domain channel response when reported to the LMF and used for input of LMF-side AI/ML positioning model. The reporting of this enhanced, dedicated, or new signaling may happen as part of capability messaging. There may also be an enhanced, dedicated, or new LPP signaling from an LMF to a UE in which the LMF may request the UE to apply additional condition related to processing the UE does to obtain the time-domain channel response, where reporting of this enhanced, dedicated, or new signaling may happen as part of request location messaging.

As discussed above and also for purposes of the present disclosure, “additional conditions” may refer to the capabilities of a UE/TRP related to the processing that the UE/TRP does to obtain channel response(s). For example, the “additional conditions” may include the indexing of procedure/method used by a UE/TRP, where the indexing may be freely selected by the UE/TRP and the UE/TRP is expected to keep this indexing consistent. In some examples, this indexing may also be configured to apply to a plurality of UEs (e.g., a UE-group of the same vendor) and/or to a plurality of TRPs. In another example, the “additional conditions” may include the brief information related to the procedure/method used by the UE/TRP. For example, the brief information may include an explicit indication of sampling period/rate used for processing, an indication on whether sampling period is consistent with RS bandwidth and subcarrier spacing, and/or an indication on whether time-domain channel response is aligned with sampling grid or off-grid. A network entity (e.g., the network entity 1104, a location server, an LMF, etc.) may use the indicated indexing and/or brief information related to RS measurement processing applied by the UE/TRP to obtain time-domain channel response for AI/ML positioning related operation(s) (e.g., training and/or inference). For example, the network entity may use the additional input for AI/ML positioning model, for selecting an AI/ML positioning model, and/or for selecting/switching layer(s) in an AI/ML positioning model.

Similarly, the list of capabilities may be non-confidential/non-proprietary information. For example, at 1124, the UE 1102 may indicate to the network entity 1104 that the UE 1102 supports oversampling and super resolution. At 1126, the network entity 1104 may request the UE 1102 to apply oversampling to the RS measurements. At 1110, based on the request, the UE 1102 may apply oversampling to the RS measurements (with the specific set of parameters that may be unknown to the network entity 1104) to obtain the channel response. At 1114/1116, the UE 1102 may transmit the channel response along with the index/brief information (corresponding to the oversampling and the corresponding specific set of parameters) to the network entity 1104. Similarly, such configuration may enable the network entity 1104 to obtain additional channel response(s) with consistent RS measurement processing techniques/parameters without knowing the specifics of the processing techniques/parameters.

Depending on implementations, aspects discussed in connection with FIG. 11 (e.g., associating index/brief information with RS measurement processing technique(s)/parameter(s)) may apply to various stages of an AI/ML positioning operation, such as to data collection, AI/ML model development, AI/ML model training, and/or AI/ML operation (e.g., inference), etc.

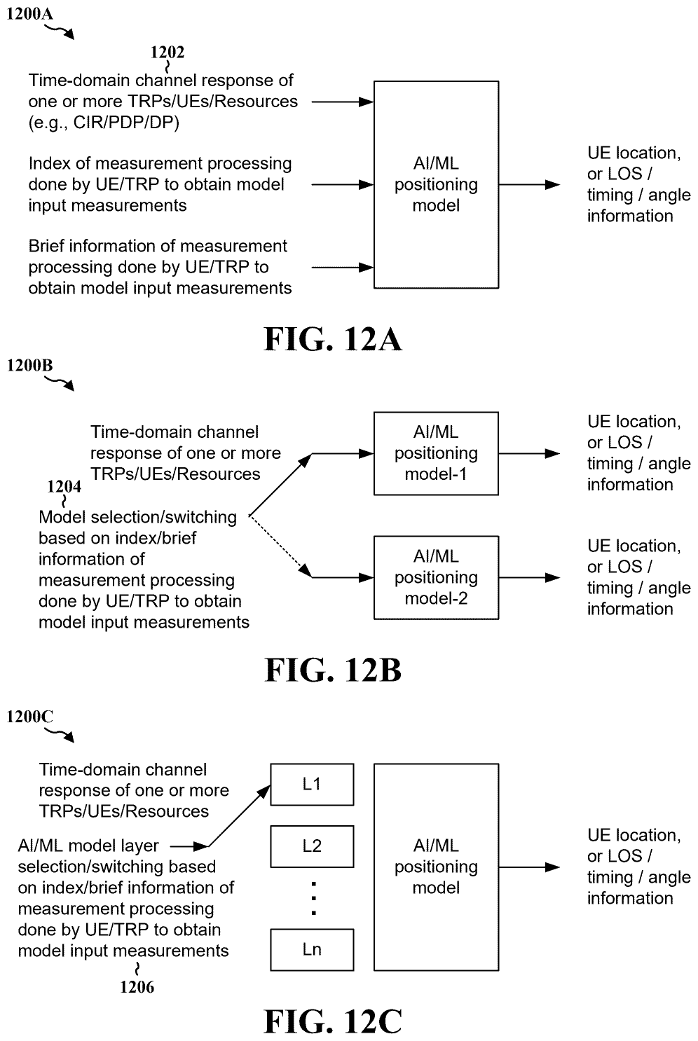

FIG. 12A is a diagram 1200A illustrating an example of an LMF-side AI/ML positioning model with UE/TRP additional conditions (supported capabilities) on channel response/model input generation in accordance with various aspects of the present disclosure. In one example, as shown at 1202, the channel response measured by a UE (e.g., the UE 1102) or a base station/TRP, the index of the RS measurement processing done by the UE/base station/TRP, and the brief information of the RS measurement processing may be used as input for an AI/ML positioning model (e.g., an AI/ML positioning model at a location server such as an LMF). Then, based on the input, the AI/ML positioning model may perform AI/ML positioning related operation(s) (e.g., data collection, training, inference, etc.). For example, the AI/ML positioning model may be configured to determine/derive the location of a UE, or obtain positioning related information of a UE, such as LOS/NLOS condition, timing information (e.g., TDoA, RSTD, etc.), angle information (e.g., AoA, AoD, etc.), etc. FIG. 12B is a diagram 1200B illustrating an example of an LMF-side AI/ML positioning model with UE/TRP additional conditions (supported capabilities) on channel response/model input generation in accordance with various aspects of the present disclosure. In another example, as shown at 1204, in addition to using the channel response from one or more UEs/TRPs as input to an AI/ML positioning model, the index of the RS measurement processing done by the UE/base station/TRP and/or the brief information of the RS measurement processing may also be used by (e.g., the location server/LMF) for selecting/switching an AI/ML positioning model for performing AI/ML positioning related operation(s). For example, based on the index and the brief information, an LMF may select a first AI/ML positioning model (among two AI/ML positioning models) and perform AI/ML positioning related operation(s) using the first AI/ML positioning model. For example, the first AI/ML positioning model may be train using the channel response, or the first AI/ML positioning model may be configured to determine/derive the location of a UE, or obtain positioning related information of the UE, etc.

FIG. 12C is a diagram 1200C illustrating an example of an LMF-side AI/ML positioning model with UE/TRP additional conditions (supported capabilities) on channel response/model input generation in accordance with various aspects of the present disclosure. In another example, as shown at 1206, in addition to using the channel response from one or more UEs/TRPs as input to an AI/ML positioning model, the index of the RS measurement processing done by the UE/base station/TRP and/or the brief information of the RS measurement processing may also be used by (e.g., the location server/LMF) for selecting/switching an AI/ML positioning model layer for performing AI/ML positioning related operation(s). For example, based on the index and the brief information, an LMF may select a first layer (L1) of an AI/ML positioning model (among n AI/ML positioning model layers (e.g., L1 to Ln)) and perform AI/ML positioning related operation(s) using the selected AI/ML positioning model layer. For example, the AI/ML positioning model layer may be train using the channel response.

Referring back to FIG. 11, as shown at 1128, the network entity 1104 may collect channel responses and their associated indexing/brief information from a plurality of UEs and/or TRPs. Depending on implementations, the indication of indexing and/or the brief information may be configured for the UE(s)/TRP(s) during data collections for AI/ML model development and training, and/or for provisioning during inferences.

In one aspect of the present disclosure, the network entity 1104 (e.g., an LMF) may be configured to use the indicated indexing and/or brief information to ensure AI/ML model input consistency between training and inference. For example, at an inference time, the network entity 1104 may receive the indexing and/or the brief information related to channel response generation and check if an AI/ML model is valid. If the network entity 1104 determines an AI/ML model is not valid, the network entity 1104 may switch the AI/ML model or switch weights/layers of the AI/ML model to ensure consistency, such as discussed in connection with FIGS. 12B and 12C. In addition, as discussed in connection with FIG. 12A, the network entity 1104 may use the indexing and/or the brief information as input to the AI/ML model (e.g., for inferring the location or positioning related information of a UE).

In another aspect of the present disclosure, the network entity 1104 may receive a first indexing and/or brief information from a first UE/TRP, and receive a second indexing and/or brief information from a second UE/TRP. Then, the network entity 1104 may be configured to use a first AI/ML model or a first layer/weight with measurements reported by the first UE/TRP, and use a second AI/ML model or a second layers/weights with measurements reported by the second UE/TRP.

In another aspect of the present disclosure, the network entity 1104 may receive a first indexing and/or brief information from a first UE/TRP and receive a second indexing and/or brief information from the first UE/TRP at a different timing or measurement occasion. Then, the network entity 1104 may use a first AI/ML model or a first layer/weight with measurements reported by the first UE/TRP for a first timing or a first measurement occasion, and use a second AI/ML model or a second layers/weights with measurements reported by the first UE/TRP for a second timing or a second measurement occasion.

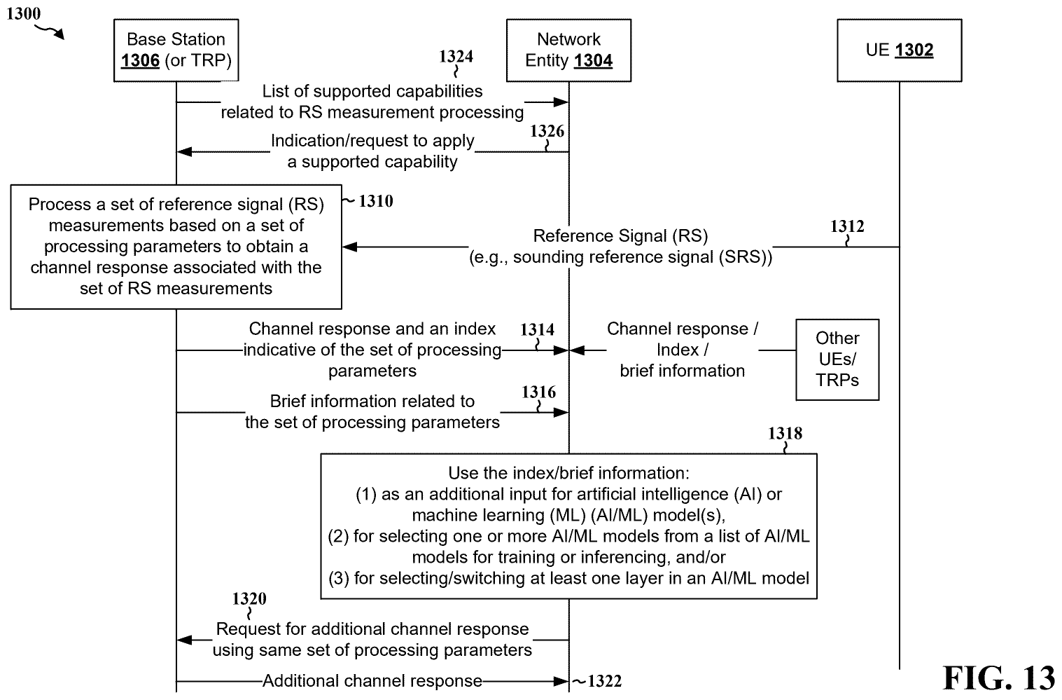

FIG. 13 is a communication flow 1300 illustrating an example procedure of a base station/TRP indicating to a location server an indexing and/or brief information related to processing of RS measurements in accordance with various aspects of the present disclosure. The numberings associated with the communication flow 1300 do not specify a particular temporal order and are merely used as references for the communication flow 1300.

At 1310, a base station or one or more of its TRPs (collectively as the “base station 1306”) may be configured to measure a set of RS to obtain a set of RS measurements, and process the set of RS measurements using at least one RS measurement processing technique (e.g., oversampling, super resolution, interpolation, etc.) (collectively as “a set of processing parameters”) to obtain a channel response associated with the set of RS measurements. As shown at 1312, the set of RS may be a set of sounding reference signals (SRS) transmitted from at least one UE 1302. As discussed above, the channel response may be a time-domain channel response, such as a CIR, a PDP, a DP, first path measurement(s), additional path measurement(s) (e.g., may include power, timing, and/or phase information of measurement), or a combination thereof. In some examples, the channel response may also be a time-domain channel response such as a CFR.

At 1314, based on the obtained channel response, the base station 1306 may transmit, to a network entity 1304 (e.g., a server, a location server, an LMF, etc.), the channel response and an index (or indexing) indicative of the set of processing parameters. In one example, different indices may correspond to different sets of processing parameters. For example, a first index (index #1) may correspond to an oversampling processing technique with a first set of oversampling parameters, a second index (index #2) may correspond to an oversampling processing technique with a second set of oversampling parameters, and a third index (index #3) may correspond to an interpolation processing technique with a set of interpolation parameters, etc. In some examples, the index may be considered as an additional condition of the base station 1306 for supporting AI/ML positioning models running at a network side (e.g., an LMF side). The base station 1306 may be configured to freely select different indices for different processing parameters as long as the base station 1306 is able to keep it consistent overtime. For example, if the base station 1306 selects the first index to indicate an oversampling processing technique with a specific set of oversampling parameters, the base station 1306 is expected to use the same index whenever the base station 1306 applies the same oversampling processing technique with the same specific set of oversampling parameters to RS measurement(s).

In some implementations, as shown at 1316, the base station 1306 may also transmit, to the network entity 1304, brief information related the set of processing parameters. The brief information may be some high-level information related to the RS processing techniques and/or their parameters. In one configuration, the brief information may be configured to be non-proprietary or non-confidential information (e.g., the set of processing parameters may be related to proprietary or confidential information, but the index/brief information may be related to non-proprietary or non-confidential information). For example, the brief information may be a sampling rate for the processing of the set of RS measurements, a sampling period for the processing of the set of RS measurements, an indication of whether the sampling period is consistent with an RS bandwidth and SCS, and/or an indication of whether a reported channel response is aligned with a sampling grid or is off-grid, etc. Note while the communication flow 1300 shows the base station 1306 transmits the channel response/index and the brief information via different signaling, it is merely for illustration purposes. In some examples, the brief information may be transmitted with the channel response and the index, or the brief information may be optional or skipped.

In some examples, the transmission/application of the index/brief information related to the RS measurement processing by the base station 1306 may be based on an indication from the network entity 1304 that the channel response is going to be used for AI/ML positioning related operation(s). For example, prior to the base station 1306 processes the set of RS measurements at 1310, the network entity 1304 may transmit an indication (not shown in the communication flow 1300) to the base station 1306 that the channel responses from the base station 1306 are going to be used for AI/ML positioning related operation(s) (e.g., for data collection, AI/ML model training, AI/ML model inferencing, etc.). Then, based on the indication, the base station 1306 may include the index/brief information corresponding to the RS measurement processing performed by the base station 1306 as described above. However, if the network entity 1304 does not transmit the indication, then the base station 1306 may just report the channel response without the index/brief information to reduce the signaling overhead.

At 1318, based on the channel response, the index, and/or the brief information, the network entity 1304 may be configured to use the index/brief information as an additional input for AI/ML model(s), use the index/brief information to select one or more AI/ML models from a list of AI/ML models for training and/or inferencing, and/or (3) use the index/brief information to select and/or switch at least one layer in an AI/ML model, etc.

In some examples, the network entity 1304 may request the base station 1306 to apply one or more of RS measurement processing methods supported by the base station 1306 by indicating the indexing and/or the brief information. For example, as shown at 1320, after the network entity 1304 learns the index and/or the brief information associated with a channel response (e.g., at 1314 and 1316), if the network entity 1304 would like to request the base station 1306 to provide additional channel response(s) using the same set of processing parameters (e.g., using the same RS measurement processing technique(s) or parameter(s) as 1310), the network entity 1304 may make the request using the learned index and/or the brief information. At 1322, in response to the request, the base station 1306 may process another set of RS using the same set of processing parameters (associated with the index/brief information) to obtain additional channel response(s), and the base station 1306 may transmit the additional channel response(s) to the network entity 1304. Such configuration may enable the network entity 1304 to obtain additional channel response(s) with consistent RS measurement processing techniques/parameters without knowing the specifics of the processing techniques/parameters (which may be confidential/proprietary to the UE vendor).

In another example, as shown at 1324, the base station 1306 may be configured to transmit, to the network entity 1304, a list of capabilities related to RS measurement processing supported by the base station 1306 for obtaining channel responses. Depending on implementations, the capabilities may also be referred to as “additional conditions” and/or “supported capabilities.” At 1326, based on the list of capabilities supported by the base station 1306, the network entity 1304 may indicate/request the base station 1306 to apply at least one of the capabilities for processing the RS measurements.

Similarly, the list of capabilities may be non-confidential/non-proprietary information. For example, at 1324, the base station 1306 may indicate to the network entity 1304 that the base station 1306 supports oversampling and super resolution. At 1326, the network entity 1304 may request the base station 1306 to apply oversampling to the RS measurements. At 1310, based on the request, the base station 1306 may apply oversampling to the RS measurements (with the specific set of parameters that may be unknown to the network entity 1304) to obtain the channel response. At 1314/1316, the base station 1306 may transmit the channel response along with the index/brief information (corresponding to the oversampling and the corresponding specific set of parameters) to the network entity 1304. Similarly, such configuration may enable the network entity 1304 to obtain additional channel response(s) with consistent RS measurement processing techniques/parameters without knowing the specifics of the processing techniques/parameters.

Depending on implementations, aspects discussed in connection with FIG. 13 (e.g., associating index/brief information with RS measurement processing technique(s)/parameter(s)) may apply to various stages of an AI/ML positioning operation, such as to data collection, AI/ML model development, AI/ML model training, and/or AI/ML operation (e.g., inference), etc.

As shown at 1328, the network entity 1304 may collect channel responses and their associated indexing/brief information from a plurality of UEs and/or TRPs. Depending on implementations, the indication of indexing and/or the brief information may be configured for the UE(s)/TRP(s) during data collections for AI/ML model development and training, and/or for provisioning during inferences.

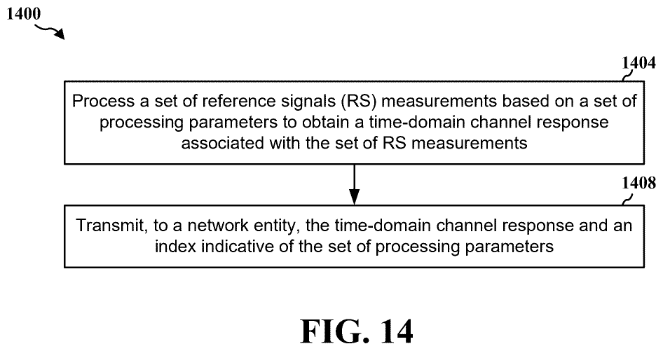

FIG. 14 is a flowchart 1400 of wireless communication. The method may be performed by a wireless device (e.g., the UE 104, 404, 1102; the base station 102, 1306; the apparatus 1604; the network entity 1702). The method may enable the wireless device (e.g., a UE or a base station/TRP) to indicate measurement processing done by the wireless device using indexing/brief information when reporting RS measurements for AI/ML model input without revealing confidential/proprietary information, thereby ensuring a consistency between AI/ML positioning models and other reporting entities/nodes as well as a consistency between training and inference for a given AI/ML positioning model.

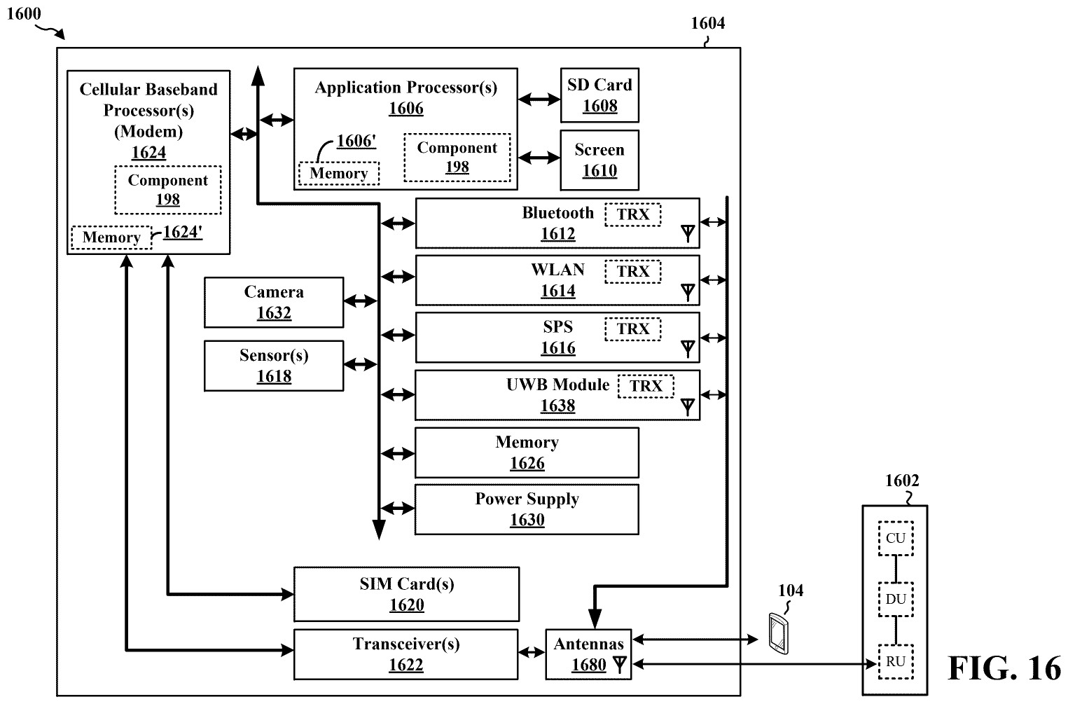

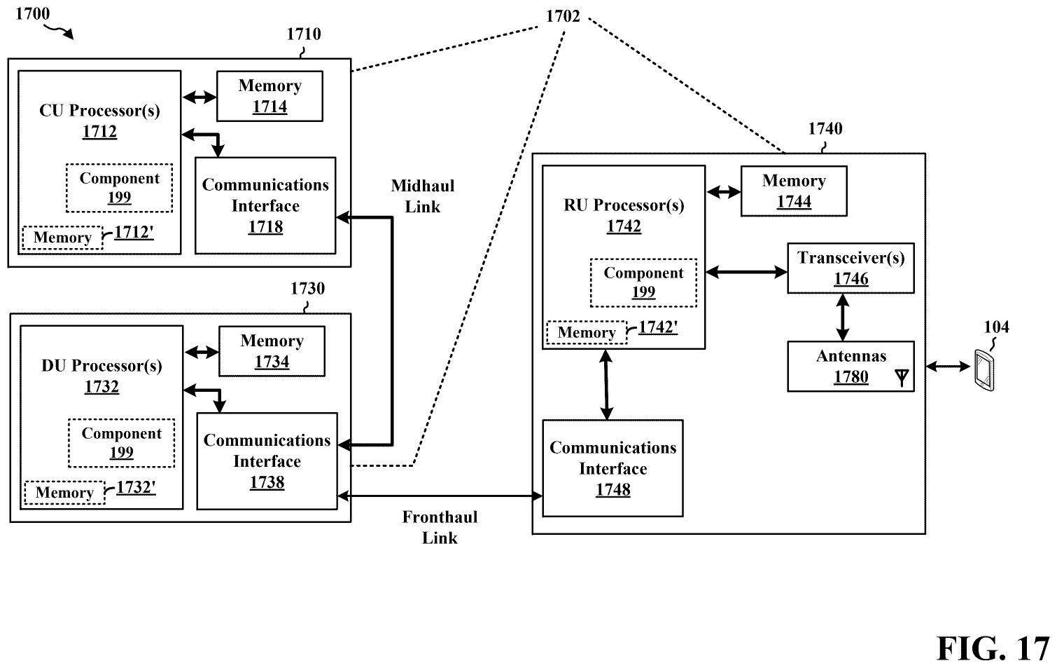

At 1404, the wireless device may process a set of RS measurements based on a set of processing parameters to obtain a time-domain channel response associated with the set of RS measurements, such as described in connection with FIGS. 11 and 13. For example, as discussed in connection with 1110 of FIG. 11, a UE 1102 may be configured to measure a set of RS to obtain a set of RS measurements, and process the set of RS measurements using at least one RS measurement processing technique (e.g., oversampling, super resolution, interpolation, etc.) (collectively as “a set of processing parameters”) to obtain a channel response associated with the set of RS measurements. The process of the set of RS measurements may be performed by, e.g., the measurement processing indication component 198, the transceiver(s) 1622, the cellular baseband processor(s) 1624, and/or the application processor(s) 1606 of the apparatus 1604 in FIG. 16. The process of the set of RS measurements may also be performed by, e.g., the measurement processing indication component 199, the transceiver(s) 1746, the RU processor(s) 1742, the DU processor(s) 1732, and/or the CU processor(s) 1712, of the network entity 1702 in FIG. 17.

In one example, the set of processing parameters is related to proprietary or confidential information, and where the index is related to non-proprietary or non-confidential information.

In another example, the set of processing parameters includes at least one of: a first set of parameters related to oversampling, a second set of parameters related to super resolution, or a third set of parameters related to interpolation.

In another example, the time-domain channel response includes at least one of: a CIR, a PDP, a DP, a first path measurement, or an additional path measurement.

At 1408, the wireless device may transmit, to a network entity, the time-domain channel response and an index indicative of the set of processing parameters, such as described in connection with FIGS. 11 and 13. For example, as discussed in connection with 1114 of FIG. 11, based on the obtained channel response, the UE 1102 may transmit, to a network entity 1104 (e.g., a server, a location server, an LMF, etc.), the channel response and an index (or indexing) indicative of the set of processing parameters. The transmission of the time-domain channel response and the index may be performed by, e.g., the measurement processing indication component 198, the transceiver(s) 1622, the cellular baseband processor(s) 1624, and/or the application processor(s) 1606 of the apparatus 1604 in FIG. 16. The transmission of the time-domain channel response and the index may also be performed by, e.g., the measurement processing indication component 199, the transceiver(s) 1746, the RU processor(s) 1742, the DU processor(s) 1732, and/or the CU processor(s) 1712, of the network entity 1702 in FIG. 17.

In one example, the wireless device may receive, from the network entity, an indication that the time-domain channel response is used in association with one or more AI/ML models at the network entity, where transmission of the index is based on the indication, such as described in connection with FIGS. 11 and 13. For example, as discussed in connection with FIG. 11, in some examples, the transmission/application of the index/brief information related to the RS measurement processing by the UE 1102 may be based on an indication from the network entity 1104 that the channel response is going to be used for AI/ML positioning related operation(s). For example, prior to the UE 1102 processes the set of RS measurements at 1110, the network entity 1104 may transmit an indication (not shown in the communication flow 1100) to the UE 1102 that the channel responses from the UE 1102 are going to be used for AI/ML positioning related operation(s) (e.g., for data collection, AI/ML model training, AI/ML model inferencing, etc.). The reception of the indication may be performed by, e.g., the measurement processing indication component 198, the transceiver(s) 1622, the cellular baseband processor(s) 1624, and/or the application processor(s) 1606 of the apparatus 1604 in FIG. 16. The reception of the indication may also be performed by, e.g., the measurement processing indication component 199, the transceiver(s) 1746, the RU processor(s) 1742, the DU processor(s) 1732, and/or the CU processor(s) 1712, of the network entity 1702 in FIG. 17.

In another example, the wireless device may transmit, to the network entity, information related the set of processing parameters, such as described in connection with FIGS. 11 and 13. For example, as discussed in connection with 1116 of FIG. 11, the UE 1102 may also transmit, to the network entity 1104, brief information related the set of processing parameters. The brief information may be some high-level information related to the RS processing techniques and/or their parameters. The transmission of the information may be performed by, e.g., the measurement processing indication component 198, the transceiver(s) 1622, the cellular baseband processor(s) 1624, and/or the application processor(s) 1606 of the apparatus 1604 in FIG. 16. The transmission of the information measurements may also be performed by, e.g., the measurement processing indication component 199, the transceiver(s) 1746, the RU processor(s) 1742, the DU processor(s) 1732, and/or the CU processor(s) 1712, of the network entity 1702 in FIG. 17. In some implementations, the information includes at least one of: a sampling rate for the processing of the set of RS measurements, a sampling period for the processing of the set of RS measurements, a first indication of whether the sampling period is consistent with an RS bandwidth and SCS, or a second indication of whether a reported channel response is aligned with a sampling grid or is off-grid.

In another example, the wireless device may select the index for the set of processing parameters, and apply the index for subsequent processing of RS measurements that uses the set of processing parameters, such as described in connection with FIGS. 11 and 13. For example, as discussed in connection with FIG. 11, the UE 1102 may be configured to freely select different indices for different processing parameters as long as the UE 1102 is able to keep it consistent overtime. For example, if the UE 1102 selects the first index to indicate an oversampling processing technique with a specific set of oversampling parameters, the UE 1102 is expected to use the same index whenever the UE 1102 applies the same oversampling processing technique with the same specific set of oversampling parameters to RS measurement(s). The selection of the index and/or the application of the index may be performed by, e.g., the measurement processing indication component 198, the transceiver(s) 1622, the cellular baseband processor(s) 1624, and/or the application processor(s) 1606 of the apparatus 1604 in FIG. 16. The selection of the index and/or the application of the index may also be performed by, e.g., the measurement processing indication component 199, the transceiver(s) 1746, the RU processor(s) 1742, the DU processor(s) 1732, and/or the CU processor(s) 1712, of the network entity 1702 in FIG. 17.

In another example, the wireless device may transmit, to the network entity, a list of supported capabilities related to RS processing for obtaining time-domain channel responses, such as described in connection with FIGS. 11 and 13. For example, as discussed in connection with 1124 of FIG. 11, the UE 1102 may be configured to transmit, to the network entity 1104, a list of capabilities related to RS measurement processing supported by the UE 1102 for obtaining channel responses. The transmission of the list of supported capabilities may be performed by, e.g., the measurement processing indication component 198, the transceiver(s) 1622, the cellular baseband processor(s) 1624, and/or the application processor(s) 1606 of the apparatus 1604 in FIG. 16. The transmission of the list of supported capabilities may also be performed by, e.g., the measurement processing indication component 199, the transceiver(s) 1746, the RU processor(s) 1742, the DU processor(s) 1732, and/or the CU processor(s) 1712, of the network entity 1702 in FIG. 17. In some implementations, to transmit the list of supported capabilities, the wireless device may be configured to transmit the list of supported capabilities via a capability message. In some implementation, the wireless device may further receive, from the network entity based on the list of supported capabilities, an indication to apply at least one supported capability in the list of supported capabilities for the processing of the set of RS measurements, where the set of processing parameters is associated with the at least one supported capability. In some implementations, to receive the indication, the wireless device may be configured to receive the indication via a request location message.

In another example, the network entity is a location server or an LMF, and the wireless device is a UE or a base station.

In another example, the index is associated with a set of indices and the set of processing parameters is associated with a plurality of sets of processing parameters, where different indices in the set of indices correspond to different sets of processing parameters in the plurality of sets of processing parameters.

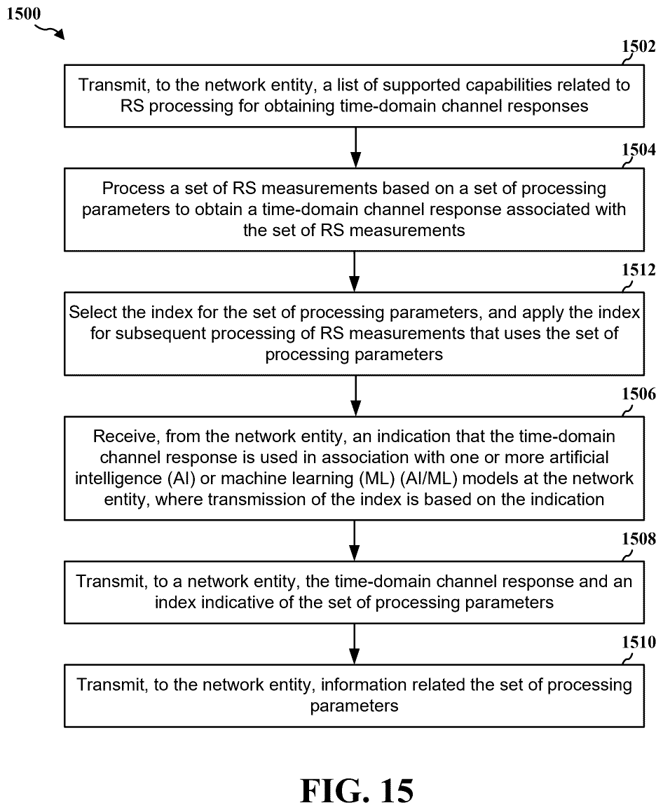

FIG. 15 is a flowchart 1500 of wireless communication. The method may be performed by a wireless device (e.g., the UE 104, 404, 1102; the base station 102, 1306; the apparatus 1604; the network entity 1702). The method may enable the wireless device (e.g., a UE or a base station/TRP) to indicate measurement processing done by the wireless device using indexing/brief information when reporting RS measurements for AI/ML model input without revealing confidential/proprietary information, thereby ensuring a consistency between AI/ML positioning models and other reporting entities/nodes as well as a consistency between training and inference for a given AI/ML positioning model.

At 1504, the wireless device may process a set of RS measurements based on a set of processing parameters to obtain a time-domain channel response associated with the set of RS measurements, such as described in connection with FIGS. 11 and 13. For example, as discussed in connection with 1110 of FIG. 11, a UE 1102 may be configured to measure a set of RS to obtain a set of RS measurements, and process the set of RS measurements using at least one RS measurement processing technique (e.g., oversampling, super resolution, interpolation, etc.) (collectively as “a set of processing parameters”) to obtain a channel response associated with the set of RS measurements. The process of the set of RS measurements may be performed by, e.g., the measurement processing indication component 198, the transceiver(s) 1622, the cellular baseband processor(s) 1624, and/or the application processor(s) 1606 of the apparatus 1604 in FIG. 16. The process of the set of RS measurements may also be performed by, e.g., the measurement processing indication component 199, the transceiver(s) 1746, the RU processor(s) 1742, the DU processor(s) 1732, and/or the CU processor(s) 1712, of the network entity 1702 in FIG. 17.

In one example, the set of processing parameters is related to proprietary or confidential information, and where the index is related to non-proprietary or non-confidential information.

In another example, the set of processing parameters includes at least one of: a first set of parameters related to oversampling, a second set of parameters related to super resolution, or a third set of parameters related to interpolation.

In another example, the time-domain channel response includes at least one of: a CIR, a PDP, a DP, a first path measurement, or an additional path measurement.

At 1508, the wireless device may transmit, to a network entity, the time-domain channel response and an index indicative of the set of processing parameters, such as described in connection with FIGS. 11 and 13. For example, as discussed in connection with 1114 of FIG. 11, based on the obtained channel response, the UE 1102 may transmit, to a network entity 1104 (e.g., a server, a location server, an LMF, etc.), the channel response and an index (or indexing) indicative of the set of processing parameters. The transmission of the time-domain channel response and the index may be performed by, e.g., the measurement processing indication component 198, the transceiver(s) 1622, the cellular baseband processor(s) 1624, and/or the application processor(s) 1606 of the apparatus 1604 in FIG. 16. The transmission of the time-domain channel response and the index may also be performed by, e.g., the measurement processing indication component 199, the transceiver(s) 1746, the RU processor(s) 1742, the DU processor(s) 1732, and/or the CU processor(s) 1712, of the network entity 1702 in FIG. 17.

In one example, as shown at 1506, the wireless device may receive, from the network entity, an indication that the time-domain channel response is used in association with one or more AI/ML models at the network entity, where transmission of the index is based on the indication, such as described in connection with FIGS. 11 and 13. For example, as discussed in connection with FIG. 11, in some examples, the transmission/application of the index/brief information related to the RS measurement processing by the UE 1102 may be based on an indication from the network entity 1104 that the channel response is going to be used for AI/ML positioning related operation(s). For example, prior to the UE 1102 processes the set of RS measurements at 1110, the network entity 1104 may transmit an indication (not shown in the communication flow 1100) to the UE 1102 that the channel responses from the UE 1102 are going to be used for AI/ML positioning related operation(s) (e.g., for data collection, AI/ML model training, AI/ML model inferencing, etc.). The reception of the indication may be performed by, e.g., the measurement processing indication component 198, the transceiver(s) 1622, the cellular baseband processor(s) 1624, and/or the application processor(s) 1606 of the apparatus 1604 in FIG. 16. The reception of the indication may also be performed by, e.g., the measurement processing indication component 199, the transceiver(s) 1746, the RU processor(s) 1742, the DU processor(s) 1732, and/or the CU processor(s) 1712, of the network entity 1702 in FIG. 17.

In another example, as shown at 1510, the wireless device may transmit, to the network entity, information related the set of processing parameters, such as described in connection with FIGS. 11 and 13. For example, as discussed in connection with 1116 of FIG. 11, the UE 1102 may also transmit, to the network entity 1104, brief information related the set of processing parameters. The brief information may be some high-level information related to the RS processing techniques and/or their parameters. The transmission of the information may be performed by, e.g., the measurement processing indication component 198, the transceiver(s) 1622, the cellular baseband processor(s) 1624, and/or the application processor(s) 1606 of the apparatus 1604 in FIG. 16. The transmission of the information measurements may also be performed by, e.g., the measurement processing indication component 199, the transceiver(s) 1746, the RU processor(s) 1742, the DU processor(s) 1732, and/or the CU processor(s) 1712, of the network entity 1702 in FIG. 17. In some implementations, the information includes at least one of: a sampling rate for the processing of the set of RS measurements, a sampling period for the processing of the set of RS measurements, a first indication of whether the sampling period is consistent with an RS bandwidth and SCS, or a second indication of whether a reported channel response is aligned with a sampling grid or is off-grid.

In another example, as shown at 1512, the wireless device may select the index for the set of processing parameters, and apply the index for subsequent processing of RS measurements that uses the set of processing parameters, such as described in connection with FIGS. 11 and 13. For example, as discussed in connection with FIG. 11, the UE 1102 may be configured to freely select different indices for different processing parameters as long as the UE 1102 is able to keep it consistent overtime. For example, if the UE 1102 selects the first index to indicate an oversampling processing technique with a specific set of oversampling parameters, the UE 1102 is expected to use the same index whenever the UE 1102 applies the same oversampling processing technique with the same specific set of oversampling parameters to RS measurement(s). The selection of the index and/or the application of the index may be performed by, e.g., the measurement processing indication component 198, the transceiver(s) 1622, the cellular baseband processor(s) 1624, and/or the application processor(s) 1606 of the apparatus 1604 in FIG. 16. The selection of the index and/or the application of the index may also be performed by, e.g., the measurement processing indication component 199, the transceiver(s) 1746, the RU processor(s) 1742, the DU processor(s) 1732, and/or the CU processor(s) 1712, of the network entity 1702 in FIG. 17.

In another example, as shown at 1502, the wireless device may transmit, to the network entity, a list of supported capabilities related to RS processing for obtaining time-domain channel responses, such as described in connection with FIGS. 11 and 13. For example, as discussed in connection with 1124 of FIG. 11, the UE 1102 may be configured to transmit, to the network entity 1104, a list of capabilities related to RS measurement processing supported by the UE 1102 for obtaining channel responses. The transmission of the list of supported capabilities may be performed by, e.g., the measurement processing indication component 198, the transceiver(s) 1622, the cellular baseband processor(s) 1624, and/or the application processor(s) 1606 of the apparatus 1604 in FIG. 16. The transmission of the list of supported capabilities may also be performed by, e.g., the measurement processing indication component 199, the transceiver(s) 1746, the RU processor(s) 1742, the DU processor(s) 1732, and/or the CU processor(s) 1712, of the network entity 1702 in FIG. 17. In some implementations, to transmit the list of supported capabilities, the wireless device may be configured to transmit the list of supported capabilities via a capability message. In some implementation, the wireless device may further receive, from the network entity based on the list of supported capabilities, an indication to apply at least one supported capability in the list of supported capabilities for the processing of the set of RS measurements, where the set of processing parameters is associated with the at least one supported capability. In some implementations, to receive the indication, the wireless device may be configured to receive the indication via a request location message.

In another example, the network entity is a location server or an LMF, and the wireless device is a UE or a base station.

In another example, the index is associated with a set of indices and the set of processing parameters is associated with a plurality of sets of processing parameters, where different indices in the set of indices correspond to different sets of processing parameters in the plurality of sets of processing parameters.

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include at least one cellular baseband processor 1624 (also referred to as a modem) coupled to one or more transceivers 1622 (e.g., cellular RF transceiver). The cellular baseband processor(s) 1624 may include at least one on-chip memory 1624′. In some aspects, the apparatus 1604 may further include one or more subscriber identity modules (SIM) cards 1620 and at least one application processor 1606 coupled to a secure digital (SD) card 1608 and a screen 1610. The application processor(s) 1606 may include on-chip memory 1606′. In some aspects, the apparatus 1604 may further include a Bluetooth module 1612, a WLAN module 1614, an ultrawide band (UWB) module 1638 (e.g., a UWB transceiver), an SPS module 1616 (e.g., GNSS module), one or more sensors 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the UWB module 1638, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor(s) 1624 communicates through the transceiver(s) 1622 via one or more antennas 1680 with the UE 104 and/or with an RU associated with a network entity 1602. The cellular baseband processor(s) 1624 and the application processor(s) 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor(s) 1624 and the application processor(s) 1606 are each responsible for general processing, including the execution of software stored on the computer-readable medium/memory. The software, when executed by the cellular baseband processor(s) 1624/application processor(s) 1606, causes the cellular baseband processor(s) 1624/application processor(s) 1606 to perform the various functions described supra. The cellular baseband processor(s) 1624 and the application processor(s) 1606 are configured to perform the various functions described supra based at least in part of the information stored in the memory. That is, the cellular baseband processor(s) 1624 and the application processor(s) 1606 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1624/application processor(s) 1606 when executing software. The cellular baseband processor(s) 1624/application processor(s) 1606 may be a component of the UE 350 and may include the at least one memory 360 and/or at least one of the TX processor 368, the RX processor 356, and the controller/processor 359. In one configuration, the apparatus 1604 may be at least one processor chip (modem and/or application) and include just the cellular baseband processor(s) 1624 and/or the application processor(s) 1606, and in another configuration, the apparatus 1604 may be the entire UE (e.g., see UE 350 of FIG. 3) and include the additional modules of the apparatus 1604.

As discussed supra, the measurement processing indication component 198 may be configured to process a set of RS measurements based on a set of processing parameters to obtain a time-domain channel response associated with the set of RS measurements. The measurement processing indication component 198 may also be configured to transmit, to a network entity, the time-domain channel response and an index indicative of the set of processing parameters. The measurement processing indication component 198 may be within the cellular baseband processor(s) 1624, the application processor(s) 1606, or both the cellular baseband processor(s) 1624 and the application processor(s) 1606. The measurement processing indication component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1604 may include a variety of components configured for various functions. In one configuration, the apparatus 1604, and in particular the cellular baseband processor(s) 1624 and/or the application processor(s) 1606, may include means for processing a set of RS measurements based on a set of processing parameters to obtain a time-domain channel response associated with the set of RS measurements. The apparatus 1604 may further include means for transmitting, to a network entity, the time-domain channel response and an index indicative of the set of processing parameters.

In one configuration, the set of processing parameters is related to proprietary or confidential information, and where the index is related to non-proprietary or non-confidential information.

In another configuration, the set of processing parameters includes at least one of: a first set of parameters related to oversampling, a second set of parameters related to super resolution, or a third set of parameters related to interpolation.

In another configuration, the time-domain channel response includes at least one of: a CIR, a PDP, a DP, a first path measurement, or an additional path measurement.

In another configuration, the apparatus 1604 may further include means for receiving, from the network entity, an indication that the time-domain channel response is used in association with one or more AI/ML models at the network entity, where transmission of the index is based on the indication.

In another configuration, the apparatus 1604 may further include means for transmitting, to the network entity, information related the set of processing parameters. In some implementations, the information includes at least one of: a sampling rate for the processing of the set of RS measurements, a sampling period for the processing of the set of RS measurements, a first indication of whether the sampling period is consistent with an RS bandwidth and SCS, or a second indication of whether a reported channel response is aligned with a sampling grid or is off-grid.

In another configuration, the apparatus 1604 may further include means for selecting the index for the set of processing parameters, and means for applying the index for subsequent processing of RS measurements that uses the set of processing parameters.

In another configuration, the apparatus 1604 may further include means for transmitting, to the network entity, a list of supported capabilities related to RS processing for obtaining time-domain channel responses. In some implementations, the means for transmitting the list of supported capabilities may include configuring the apparatus 1604 to transmit the list of supported capabilities via a capability message. In some implementation, the apparatus 1604 may further include means for receiving, from the network entity based on the list of supported capabilities, an indication to apply at least one supported capability in the list of supported capabilities for the processing of the set of RS measurements, where the set of processing parameters is associated with the at least one supported capability. In some implementations, the means for receiving the indication may include configuring the apparatus 1604 to receive the indication via a request location message.

In another configuration, the network entity is a location server or an LMF.

In another configuration, the index is associated with a set of indices and the set of processing parameters is associated with a plurality of sets of processing parameters, where different indices in the set of indices correspond to different sets of processing parameters in the plurality of sets of processing parameters.

The means may be the measurement processing indication component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the measurement processing indication component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include at least one CU processor 1712. The CU processor(s) 1712 may include on-chip memory 1712′. In some aspects, the CU 1710 may further include additional memory modules 1714 and a communications interface 1718. The CU 1710 communicates with the DU 1730 through a midhaul link, such as an F1 interface. The DU 1730 may include at least one DU processor 1732. The DU processor(s) 1732 may include on-chip memory 1732′. In some aspects, the DU 1730 may further include additional memory modules 1734 and a communications interface 1738. The DU 1730 communicates with the RU 1740 through a fronthaul link. The RU 1740 may include at least one RU processor 1742. The RU processor(s) 1742 may include on-chip memory 1742′. In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the measurement processing indication component 199 may be configured to process a set of RS measurements based on a set of processing parameters to obtain a time-domain channel response associated with the set of RS measurements. The measurement processing indication component 199 may also be configured to transmit, to a network entity, the time-domain channel response and an index indicative of the set of processing parameters. The measurement processing indication component 199 may be within one or more processors of one or more of the CU 1710, DU 1730, and the RU 1740. The measurement processing indication component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1702 may include a variety of components configured for various functions. In one configuration, the network entity 1702 may include means for processing a set of RS measurements based on a set of processing parameters to obtain a time-domain channel response associated with the set of RS measurements. The network entity 1702 may further include means for transmitting, to a network entity, the time-domain channel response and an index indicative of the set of processing parameters.

In one configuration, the set of processing parameters is related to proprietary or confidential information, and where the index is related to non-proprietary or non-confidential information.

In another configuration, the set of processing parameters includes at least one of: a first set of parameters related to oversampling, a second set of parameters related to super resolution, or a third set of parameters related to interpolation.

In another configuration, the time-domain channel response includes at least one of: a CIR, a PDP, a DP, a first path measurement, or an additional path measurement.

In another configuration, the network entity 1702 may further include means for receiving, from the network entity, an indication that the time-domain channel response is used in association with one or more AI/ML models at the network entity, where transmission of the index is based on the indication.

In another configuration, the network entity 1702 may further include means for transmitting, to the network entity, information related the set of processing parameters. In some implementations, the information includes at least one of: a sampling rate for the processing of the set of RS measurements, a sampling period for the processing of the set of RS measurements, a first indication of whether the sampling period is consistent with an RS bandwidth and SCS, or a second indication of whether a reported channel response is aligned with a sampling grid or is off-grid.

In another configuration, the network entity 1702 may further include means for selecting the index for the set of processing parameters, and means for applying the index for subsequent processing of RS measurements that uses the set of processing parameters.

In another configuration, the network entity 1702 may further include means for transmitting, to the network entity, a list of supported capabilities related to RS processing for obtaining time-domain channel responses. In some implementations, the means for transmitting the list of supported capabilities may include configuring the network entity 1702 to transmit the list of supported capabilities via a capability message. In some implementation, the network entity 1702 may further include means for receiving, from the network entity based on the list of supported capabilities, an indication to apply at least one supported capability in the list of supported capabilities for the processing of the set of RS measurements, where the set of processing parameters is associated with the at least one supported capability. In some implementations, the means for receiving the indication may include configuring the network entity 1702 to receive the indication via a request location message.

In another configuration, the network entity is a location server or an LMF.

In another configuration, the index is associated with a set of indices and the set of processing parameters is associated with a plurality of sets of processing parameters, where different indices in the set of indices correspond to different sets of processing parameters in the plurality of sets of processing parameters.

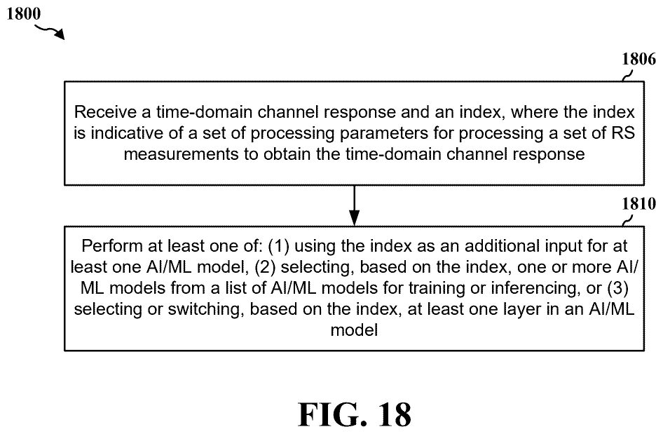

The means may be the measurement processing indication component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means. FIG. 18 is a flowchart 1800 of a method of wireless communication. The method may be performed by a network entity (e.g., the one or more location servers 168; the network entity 1104, 1304, 2060). The method may enable the network entity to ensure there is a consistency between AI/ML positioning models and other reporting entities/nodes as well as a consistency between training and inference for a given AI/ML positioning model.

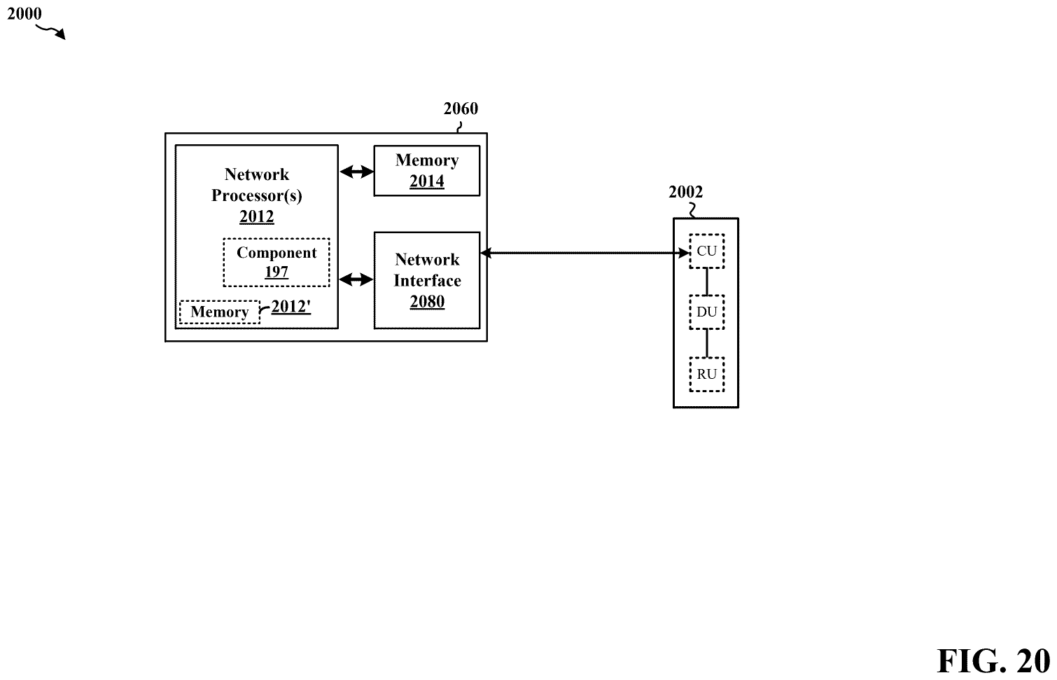

At 1806, the network entity may receive a time-domain channel response and an index, where the index is indicative of a set of processing parameters for processing a set of RS measurements to obtain the time-domain channel response, such as described in connection with FIGS. 11 and 13. For example, as described in connection with 1114 of FIG. 11, the network entity 1104 may receive, from the UE 1102, the channel response and an index (or indexing) indicative of the set of processing parameters. The reception of the time-domain channel response and the index may be performed by, e.g., the AI/ML positioning component 197, the network processor(s) 2012, and/or the network interface 2080 of the network entity 2060 in FIG. 20.

In one example, the set of processing parameters is related to proprietary or confidential information, and where the index is related to non-proprietary or non-confidential information.

In another example, the set of processing parameters includes at least one of: a first set of parameters related to oversampling, a second set of parameters related to super resolution, or a third set of parameters related to interpolation.

In another example, the time-domain channel response includes at least one of: a CIR, a PDP, a DP, a first path measurement, or an additional path measurement.

At 1810, the network entity may perform at least one of: (1) using the index as an additional input for at least one AI/ML model, (2) selecting, based on the index, one or more AI/ML models from a list of AI/ML models for training or inferencing, or (3) selecting or switching, based on the index, at least one layer in an AI/ML model, such as described in connection with FIGS. 11 and 13. For example, as described in connection with 1118 of FIG. 11, based on the channel response, the index, and/or the brief information, the network entity 1104 may be configured to use the index/brief information as an additional input for AI/ML model(s), use the index/brief information to select one or more AI/ML models from a list of AI/ML models for training and/or inferencing, and/or (3) use the index/brief information to select and/or switch at least one layer in an AI/ML model, etc. The using of the index as an additional input for at least one AI/ML model, the selection of the one or more AI/ML models from a list of AI/ML models for training or inferencing, and/or the selection or switching of the at least one layer in an AI/ML model may be performed by, e.g., the AI/ML positioning component 197, the network processor(s) 2012, and/or the network interface 2080 of the network entity 2060 in FIG. 20.

In one example, the network entity may transmit an indication that the time-domain channel response is used in association with AI/ML at the network entity, where reception of the index is based on the indication, such as described in connection with FIGS. 11 and 13. For example, as described in connection with FIG. 11, in some examples, the transmission/application of the index/brief information related to the RS measurement processing by the UE 1102 may be based on an indication from the network entity 1104 that the channel response is going to be used for AI/ML positioning related operation(s). For example, prior to the UE 1102 processes the set of RS measurements at 1110, the network entity 1104 may transmit an indication (not shown in the communication flow 1100) to the UE 1102 that the channel responses from the UE 1102 are going to be used for AI/ML positioning related operation(s) (e.g., for data collection, AI/ML model training, AI/ML model inferencing, etc.). The transmission of the indication may be performed by, e.g., the AI/ML positioning component 197, the network processor(s) 2012, and/or the network interface 2080 of the network entity 2060 in FIG. 20.

In another example, the network entity may receive information related the set of processing parameters, where the information is used as another additional input for the at least one AI/ML model, for selecting the one or more AI/ML models from the list of AI/ML models for the training or the inferencing, or for selecting or switching the at least one layer in the AI/ML model, such as described in connection with FIGS. 11 and 13. For example, as described in connection with 1116 of FIG. 11, the network entity 1104 may receive, from the UE 1102, brief information related the set of processing parameters. The brief information may be some high-level information related to the RS processing techniques and/or their parameters. The reception of the information may be performed by, e.g., the AI/ML positioning component 197, the network processor(s) 2012, and/or the network interface 2080 of the network entity 2060 in FIG. 20. In some implementations, the information includes at least one of: a sampling rate for the processing of the set of RS measurements, a sampling period for the processing of the set of RS measurements, a first indication of whether the sampling period is consistent with an RS bandwidth and SCS, or a second indication of whether a reported channel response is aligned with a sampling grid or is off-grid.

In another example, the network entity may transmit, based on using the index, a request to process a second set of RS measurements using the set of processing parameters to obtain a second time-domain channel response, and receive the second time-domain channel response, such as described in connection with FIGS. 11 and 13. For example, as described in connection with 1120 of FIG. 11, after the network entity 1104 learns the index and/or the brief information associated with a channel response (e.g., at 1114 and 1116), if the network entity 1104 would like to request the UE 1102 to provide additional channel response(s) using the same set of processing parameters (e.g., using the same RS measurement processing technique(s) or parameter(s) as 1110), the network entity 1104 may make the request using the learned index and/or the brief information. At 1122, in response to the request, the UE 1102 may process another set of RS using the same set of processing parameters (associated with the index/brief information) to obtain additional channel response(s), and the UE 1102 may transmit the additional channel response(s) to the network entity 1104. The transmission of the request and/or the reception of the second time-domain channel response may be performed by, e.g., the AI/ML positioning component 197, the network processor(s) 2012, and/or the network interface 2080 of the network entity 2060 in FIG. 20.

In another example, the network entity may receive a list of supported capabilities related to RS processing for obtaining time-domain channel responses, such as described in connection with FIGS. 11 and 13. For example, as described in connection with 1124 of FIG. 11, the network entity 1104 may receive, from the UE 1102, a list of capabilities related to RS measurement processing supported by the UE 1102 for obtaining channel responses. The reception of the list of supported capabilities may be performed by, e.g., the AI/ML positioning component 197, the network processor(s) 2012, and/or the network interface 2080 of the network entity 2060 in FIG. 20. In some implementations, to receive the list of supported capabilities, the network entity may be configured to receive the list of supported capabilities via a capability message. In some implementations, the network entity may transmit, based on the list of supported capabilities, an indication to apply at least one supported capability in the list of supported capabilities for the processing of the set of RS measurements, where the set of processing parameters is associated with the at least one supported capability. In some implementations, to transmit the indication, the network entity may be configured to transmit the indication via a request location message.

In another example, the network entity is a location server or an LMF.

In another example, the index is associated with a set of indices and the set of processing parameters is associated with a plurality of sets of processing parameters, where different indices in the set of indices correspond to different sets of processing parameters in the plurality of sets of processing parameters.

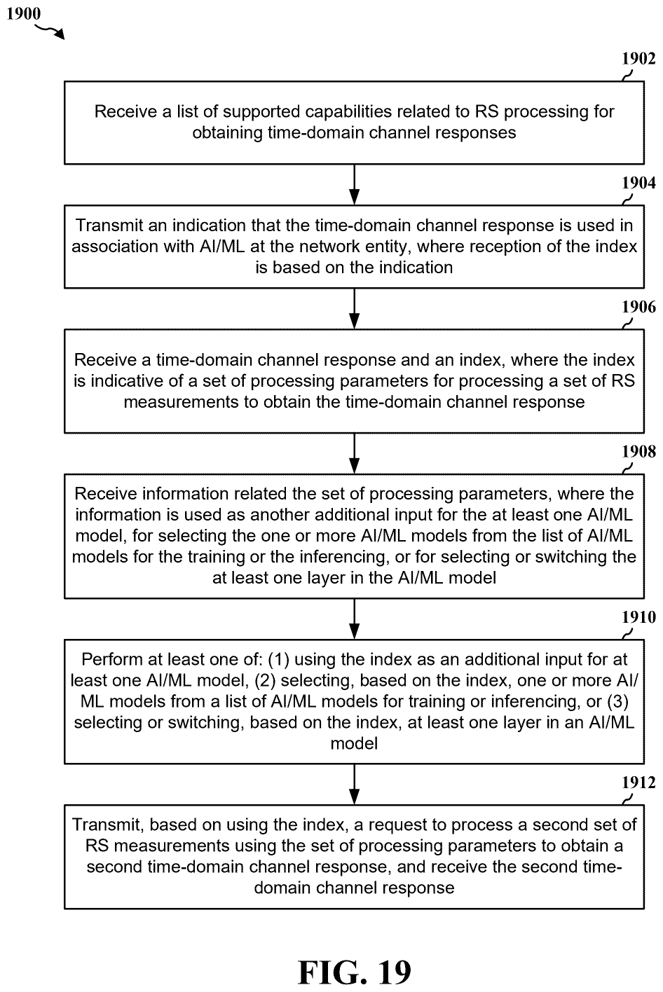

FIG. 19 is a flowchart 1900 of a method of wireless communication. The method may be performed by a network entity (e.g., the one or more location servers 168; the network entity 1104, 1304, 2060). The method may enable the network entity to ensure there is a consistency between AI/ML positioning models and other reporting entities/nodes as well as a consistency between training and inference for a given AI/ML positioning model.

At 1906, the network entity may receive a time-domain channel response and an index, where the index is indicative of a set of processing parameters for processing a set of RS measurements to obtain the time-domain channel response, such as described in connection with FIGS. 11 and 13. For example, as described in connection with 1114 of FIG. 11, the network entity 1104 may receive, from the UE 1102, the channel response and an index (or indexing) indicative of the set of processing parameters. The reception of the time-domain channel response and the index may be performed by, e.g., the AI/ML positioning component 197, the network processor(s) 2012, and/or the network interface 2080 of the network entity 2060 in FIG. 20.

In one example, the set of processing parameters is related to proprietary or confidential information, and where the index is related to non-proprietary or non-confidential information.

In another example, the set of processing parameters includes at least one of: a first set of parameters related to oversampling, a second set of parameters related to super resolution, or a third set of parameters related to interpolation.

In another example, the time-domain channel response includes at least one of: a CIR, a PDP, a DP, a first path measurement, or an additional path measurement.

At 1910, the network entity may perform at least one of: (1) using the index as an additional input for at least one AI/ML model, (2) selecting, based on the index, one or more AI/ML models from a list of AI/ML models for training or inferencing, or (3) selecting or switching, based on the index, at least one layer in an AI/ML model, such as described in connection with FIGS. 11 and 13. For example, as described in connection with 1118 of FIG. 11, based on the channel response, the index, and/or the brief information, the network entity 1104 may be configured to use the index/brief information as an additional input for AI/ML model(s), use the index/brief information to select one or more AI/ML models from a list of AI/ML models for training and/or inferencing, and/or (3) use the index/brief information to select and/or switch at least one layer in an AI/ML model, etc. The using of the index as an additional input for at least one AI/ML model, the selection of the one or more AI/ML models from a list of AI/ML models for training or inferencing, and/or the selection or switching of the at least one layer in an AI/ML model may be performed by, e.g., the AI/ML positioning component 197, the network processor(s) 2012, and/or the network interface 2080 of the network entity 2060 in FIG. 20.

In one example, as shown at 1904, the network entity may transmit an indication that the time-domain channel response is used in association with AI/ML at the network entity, where reception of the index is based on the indication, such as described in connection with FIGS. 11 and 13. For example, as described in connection with FIG. 11, in some examples, the transmission/application of the index/brief information related to the RS measurement processing by the UE 1102 may be based on an indication from the network entity 1104 that the channel response is going to be used for AI/ML positioning related operation(s). For example, prior to the UE 1102 processes the set of RS measurements at 1110, the network entity 1104 may transmit an indication (not shown in the communication flow 1100) to the UE 1102 that the channel responses from the UE 1102 are going to be used for AI/ML positioning related operation(s) (e.g., for data collection, AI/ML model training, AI/ML model inferencing, etc.). The transmission of the indication may be performed by, e.g., the AI/ML positioning component 197, the network processor(s) 2012, and/or the network interface 2080 of the network entity 2060 in FIG. 20.

In another example, as shown at 1908, the network entity may receive information related the set of processing parameters, where the information is used as another additional input for the at least one AI/ML model, for selecting the one or more AI/ML models from the list of AI/ML models for the training or the inferencing, or for selecting or switching the at least one layer in the AI/ML model, such as described in connection with FIGS. 11 and 13. For example, as described in connection with 1116 of FIG. 11, the network entity 1104 may receive, from the UE 1102, brief information related the set of processing parameters. The brief information may be some high-level information related to the RS processing techniques and/or their parameters. The reception of the information may be performed by, e.g., the AI/ML positioning component 197, the network processor(s) 2012, and/or the network interface 2080 of the network entity 2060 in FIG. 20. In some implementations, the information includes at least one of: a sampling rate for the processing of the set of RS measurements, a sampling period for the processing of the set of RS measurements, a first indication of whether the sampling period is consistent with an RS bandwidth and SCS, or a second indication of whether a reported channel response is aligned with a sampling grid or is off-grid.

In another example, as shown at 1912, the network entity may transmit, based on using the index, a request to process a second set of RS measurements using the set of processing parameters to obtain a second time-domain channel response, and receive the second time-domain channel response, such as described in connection with FIGS. 11 and 13. For example, as described in connection with 1120 of FIG. 11, after the network entity 1104 learns the index and/or the brief information associated with a channel response (e.g., at 1114 and 1116), if the network entity 1104 would like to request the UE 1102 to provide additional channel response(s) using the same set of processing parameters (e.g., using the same RS measurement processing technique(s) or parameter(s) as 1110), the network entity 1104 may make the request using the learned index and/or the brief information. At 1122, in response to the request, the UE 1102 may process another set of RS using the same set of processing parameters (associated with the index/brief information) to obtain additional channel response(s), and the UE 1102 may transmit the additional channel response(s) to the network entity 1104. The transmission of the request and/or the reception of the second time-domain channel response may be performed by, e.g., the AI/ML positioning component 197, the network processor(s) 2012, and/or the network interface 2080 of the network entity 2060 in FIG. 20.

In another example, as shown at 1902, the network entity may receive a list of supported capabilities related to RS processing for obtaining time-domain channel responses, such as described in connection with FIGS. 11 and 13. For example, as described in connection with 1124 of FIG. 11, the network entity 1104 may receive, from the UE 1102, a list of capabilities related to RS measurement processing supported by the UE 1102 for obtaining channel responses. The reception of the list of supported capabilities may be performed by, e.g., the AI/ML positioning component 197, the network processor(s) 2012, and/or the network interface 2080 of the network entity 2060 in FIG. 20. In some implementations, to receive the list of supported capabilities, the network entity may be configured to receive the list of supported capabilities via a capability message. In some implementations, the network entity may transmit, based on the list of supported capabilities, an indication to apply at least one supported capability in the list of supported capabilities for the processing of the set of RS measurements, where the set of processing parameters is associated with the at least one supported capability. In some implementations, to transmit the indication, the network entity may be configured to transmit the indication via a request location message.

In another example, the network entity is a location server or an LMF.

In another example, the index is associated with a set of indices and the set of processing parameters is associated with a plurality of sets of processing parameters, where different indices in the set of indices correspond to different sets of processing parameters in the plurality of sets of processing parameters.

FIG. 20 is a diagram 2000 illustrating an example of a hardware implementation for a network entity 2060. In one example, the network entity 2060 may be within the core network 120. The network entity 2060 may include at least one network processor 2012. The network processor(s) 2012 may include on-chip memory 2012′. In some aspects, the network entity 2060 may further include additional memory modules 2014. The network entity 2060 communicates via the network interface 2080 directly (e.g., backhaul link) or indirectly (e.g., through a RIC) with the CU 2002. The on-chip memory 2012′ and the additional memory modules 2014 may each be considered a computer-readable medium/memory. Each computer-readable medium/memory may be non-transitory. The network processor(s) 2012 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the AI/ML positioning component 197 may be configured to receive a time-domain channel response and an index, where the index is indicative of a set of processing parameters for processing a set of RS measurements to obtain the time-domain channel response. The AI/ML positioning component 197 may also be configured to perform at least one of: (1) using the index as an additional input for at least one artificial intelligence (AI) or machine learning (ML) (AI/ML) model, (2) selecting, based on the index, one or more AI/ML models from a list of AI/ML models for training or inferencing, or (3) selecting or switching, based on the index, at least one layer in an AI/ML model. The AI/ML positioning component 197 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2060 may include a variety of components configured for various functions. In one configuration, the network entity 2060 may include means for receiving a time-domain channel response and an index, where the index is indicative of a set of processing parameters for processing a set of RS measurements to obtain the time-domain channel response. The network entity 2060 may further include means for performing at least one of: (1) using the index as an additional input for at least one artificial intelligence (AI) or machine learning (ML) (AI/ML) model, (2) selecting, based on the index, one or more AI/ML models from a list of AI/ML models for training or inferencing, or (3) selecting or switching, based on the index, at least one layer in an AI/ML model.

In one configuration, the set of processing parameters is related to proprietary or confidential information, and where the index is related to non-proprietary or non-confidential information.

In another configuration, the set of processing parameters includes at least one of: a first set of parameters related to oversampling, a second set of parameters related to super resolution, or a third set of parameters related to interpolation.

In another configuration, the time-domain channel response includes at least one of: a CIR, a PDP, a DP, a first path measurement, or an additional path measurement.

In another configuration, the network entity 2060 may further include means for transmitting an indication that the time-domain channel response is used in association with AI/ML at the network entity, where reception of the index is based on the indication.

In another configuration, the network entity 2060 may further include means for receiving information related the set of processing parameters, where the information is used as another additional input for the at least one AI/ML model, for selecting the one or more AI/ML models from the list of AI/ML models for the training or the inferencing, or for selecting or switching the at least one layer in the AI/ML model. In some implementations, the information includes at least one of: a sampling rate for the processing of the set of RS measurements, a sampling period for the processing of the set of RS measurements, a first indication of whether the sampling period is consistent with an RS bandwidth and SCS, or a second indication of whether a reported channel response is aligned with a sampling grid or is off-grid.

In another configuration, the network entity 2060 may further include means for transmitting, based on using the index, a request to process a second set of RS measurements using the set of processing parameters to obtain a second time-domain channel response, and means for receiving the second time-domain channel response.

In another configuration, the network entity 2060 may further include means for receiving a list of supported capabilities related to RS processing for obtaining time-domain channel responses, such as described in connection with FIGs. In some implementations, the means for receiving the list of supported capabilities may include configuring the network entity 2060 to receive the list of supported capabilities via a capability message. In some implementations, the network entity 2060 may further include means for transmitting, based on the list of supported capabilities, an indication to apply at least one supported capability in the list of supported capabilities for the processing of the set of RS measurements, where the set of processing parameters is associated with the at least one supported capability. In some implementations, the means for transmitting the indication may include configuring the network entity 2060 to transmit the indication via a request location message.

In another configuration, the network entity is a location server or an LMF.

In another configuration, the index is associated with a set of indices and the set of processing parameters is associated with a plurality of sets of processing parameters, where different indices in the set of indices correspond to different sets of processing parameters in the plurality of sets of processing parameters.

The means may be the AI/ML positioning component 197 of the network entity 2060 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a wireless device, comprising: processing a set of reference signal (RS) measurements based on a set of processing parameters to obtain a time-domain channel response associated with the set of RS measurements; and transmitting, to a network entity, the time-domain channel response and an index indicative of the set of processing parameters.

Aspect 2 is the method of aspect 1, further comprising: receiving, from the network entity, an indication that the time-domain channel response is used in association with one or more artificial intelligence (AI) or machine learning (ML) (AI/ML) models at the network entity, wherein transmission of the index is based on the indication.

Aspect 3 is the method of aspect 1 or aspect 2, wherein the set of processing parameters is related to proprietary or confidential information, and wherein the index is related to non-proprietary or non-confidential information.

Aspect 4 is the method of any of aspects 1 to 3, further comprising: transmitting, to the network entity, information related the set of processing parameters.

Aspect 5 is the method of any of aspects 1 to 4, wherein the information includes at least one of: a sampling rate for the processing of the set of RS measurements, a sampling period for the processing of the set of RS measurements, a first indication of whether the sampling period is consistent with an RS bandwidth and subcarrier spacing (SCS), or a second indication of whether a reported channel response is aligned with a sampling grid or is off-grid.

Aspect 6 is the method of any of aspects 1 to 5, wherein the set of processing parameters includes at least one of: a first set of parameters related to oversampling, a second set of parameters related to super resolution, or a third set of parameters related to interpolation.

Aspect 7 is the method of any of aspects 1 to 6, further comprising: selecting the index for the set of processing parameters; and applying the index for subsequent processing of RS measurements that uses the set of processing parameters.

Aspect 8 is the method of any of aspects 1 to 7, wherein the time-domain channel response includes at least one of: a channel impulse response (CIR), a power delay profile (PDP), a delay profile (DP), a first path measurement, or an additional path measurement.

Aspect 9 is the method of any of aspects 1 to 8, further comprising: transmitting, to the network entity, a list of supported capabilities related to RS processing for obtaining time-domain channel responses.

Aspect 10 is the method of any of aspects 1 to 9, wherein transmitting the list of supported capabilities comprises transmitting the list of supported capabilities via a capability message.

Aspect 11 is the method of any of aspects 1 to 10, further comprising: receiving, from the network entity based on the list of supported capabilities, an indication to apply at least one supported capability in the list of supported capabilities for the processing of the set of RS measurements, wherein the set of processing parameters is associated with the at least one supported capability.

Aspect 12 is the method of any of aspects 1 to 11, wherein receiving the indication comprises receiving the indication via a request location message.

Aspect 13 is the method of any of aspects 1 to 12, wherein the network entity is a location server or a location management function (LMF), and wherein the wireless device is a user equipment (UE) or a base station.

Aspect 14 is the method of any of aspects 1 to 13, wherein the index is associated with a set of indices and the set of processing parameters is associated with a plurality of sets of processing parameters, wherein different indices in the set of indices correspond to different sets of processing parameters in the plurality of sets of processing parameters.

Aspect 15 is an apparatus for wireless communication at a wireless device, including: at least one memory; and at least one processor coupled to the at least one memory and, based at least in part on stored information that is stored in the at least one memory, the at least one processor, individually or in any combination, is configured to implement any of aspects 1 to 14.

Aspect 16 is the apparatus of aspect 15, further including at least one transceiver coupled to the at least one processor.

Aspect 17 is an apparatus for wireless communication at a wireless device including means for implementing any of aspects 1 to 14.

Aspect 18 is a computer-readable medium (e.g., a non-transitory computer-readable medium) storing computer executable code, where the code when executed by a processor causes the processor to implement any of aspects 1 to 14.

Aspect 19 is a method of wireless communication at a network entity, comprising: receiving a time-domain channel response and an index, wherein the index is indicative of a set of processing parameters for processing a set of reference signal (RS) measurements to obtain the time-domain channel response; and performing at least one of: (1) using the index as an additional input for at least one artificial intelligence (AI) or machine learning (ML) (AI/ML) model, (2) selecting, based on the index, one or more AI/ML models from a list of AI/ML models for training or inferencing, or (3) selecting or switching, based on the index, at least one layer in an AI/ML model.

Aspect 20 is the method of aspect 19, further comprising: transmitting an indication that the time-domain channel response is used in association with AI/ML at the network entity, wherein reception of the index is based on the indication.

Aspect 21 is the method of aspect 19 or aspect 20, wherein the set of processing parameters is related to proprietary or confidential information, and wherein the index is related to non-proprietary or non-confidential information.

Aspect 22 is the method of any of aspects 19 to 21, further comprising: receiving information related the set of processing parameters, wherein the information is used as another additional input for the at least one AI/ML model, for selecting the one or more AI/ML models from the list of AI/ML models for the training or the inferencing, or for selecting or switching the at least one layer in the AI/ML model.

Aspect 23 is the method of any of aspects 19 to 22, wherein the information includes at least one of: a sampling rate for the processing of the set of RS measurements, a sampling period for the processing of the set of RS measurements, a first indication of whether the sampling period is consistent with an RS bandwidth and subcarrier spacing (SCS), or a second indication of whether a reported channel response is aligned with a sampling grid or is off-grid.

Aspect 24 is the method of any of aspects 19 to 23, wherein the set of processing parameters includes at least one of: a first set of parameters related to oversampling, a second set of parameters related to super resolution, or a third set of parameters related to interpolation.

Aspect 25 is the method of any of aspects 19 to 24, further comprising: transmitting, based on using the index, a request to process a second set of RS measurements using the set of processing parameters to obtain a second time-domain channel response; and receiving the second time-domain channel response.

Aspect 26 is the method of any of aspects 19 to 25, wherein the time-domain channel response includes at least one of: a channel impulse response (CIR), a power delay profile (PDP), a delay profile (DP), a first path measurement, or an additional path measurement.

Aspect 27 is the method of any of aspects 19 to 26, further comprising: receiving a list of supported capabilities related to RS processing for obtaining time-domain channel responses.

Aspect 28 is the method of any of aspects 19 to 27, wherein receiving the list of supported capabilities comprises receiving the list of supported capabilities via a capability message.

Aspect 29 is the method of any of aspects 19 to 28, further comprising: transmitting, based on the list of supported capabilities, an indication to apply at least one supported capability in the list of supported capabilities for the processing of the set of RS measurements, wherein the set of processing parameters is associated with the at least one supported capability.

Aspect 30 is the method of any of aspects 19 to 29, wherein transmitting the indication comprises transmitting the indication via a request location message.

Aspect 31 is the method of any of aspects 19 to 30, wherein the network entity is a location server or a location management function (LMF).

Aspect 32 is the method of any of aspects 19 to 31, wherein the index is associated with a set of indices and the set of processing parameters is associated with a plurality of sets of processing parameters, wherein different indices in the set of indices correspond to different sets of processing parameters in the plurality of sets of processing parameters.

Aspect 33 is an apparatus for wireless communication at a network entity, including: at least one memory; and at least one processor coupled to the at least one memory and, based at least in part on stored information that is stored in the at least one memory, the at least one processor, individually or in any combination, is configured to implement any of aspects 19 to 32.

Aspect 34 is the apparatus of aspect 33, further including at least one transceiver coupled to the at least one processor, wherein to transmit the time-domain channel response and the index, the at least one processor is configured to transmit, via the at least one transceiver, the time-domain channel response and the index.

Aspect 35 is an apparatus for wireless communication at a second network entity including means for implementing any of aspects 19 to 32.

Aspect 36 is a computer-readable medium (e.g., a non-transitory computer-readable medium) storing computer executable code, where the code when executed by a processor causes the processor to implement any of aspects 19 to 32.

What is claimed is:

1. An apparatus for wireless communication at a wireless device, comprising:
at least one memory; and
at least one processor coupled to the at least one memory, the at least one processor, individually or in any combination, is configured to:
process a set of reference signal (RS) measurements based on a set of processing parameters to obtain a time-domain channel response associated with the set of RS measurements; and
transmit, to a network entity, the time-domain channel response and an index indicative of the set of processing parameters.

2. The apparatus of claim 1, wherein the at least one processor, individually or in any combination, is further configured to:
receive, from the network entity, an indication that the time-domain channel response is used in association with one or more artificial intelligence (AI) or machine learning (ML) (AI/ML) models at the network entity, wherein transmission of the index is based on the indication.

3. The apparatus of claim 1, wherein the set of processing parameters is related to proprietary or confidential information, and wherein the index is related to non-proprietary or non-confidential information.

4. The apparatus of claim 1, wherein the at least one processor, individually or in any combination, is further configured to:
transmit, to the network entity, information related the set of processing parameters.

5. The apparatus of claim 4, wherein the information includes at least one of:
a sampling rate for the processing of the set of RS measurements,
a sampling period for the processing of the set of RS measurements,
a first indication of whether the sampling period is consistent with an RS bandwidth and subcarrier spacing (SCS), or
a second indication of whether a reported channel response is aligned with a sampling grid or is off-grid.

6. The apparatus of claim 1, wherein the set of processing parameters includes at least one of:
a first set of parameters related to oversampling,
a second set of parameters related to super resolution, or
a third set of parameters related to interpolation.

7. The apparatus of claim 1, wherein the at least one processor, individually or in any combination, is further configured to:
select the index for the set of processing parameters; and
apply the index for subsequent processing of RS measurements that uses the set of processing parameters.

8. The apparatus of claim 1, wherein the time-domain channel response includes at least one of:
a channel impulse response (CIR),
a power delay profile (PDP),
a delay profile (DP),
a path measurement, or
an additional path measurement.

9. The apparatus of claim 1, wherein the at least one processor, individually or in any combination, is further configured to:
transmit, to the network entity, a list of supported capabilities related to RS processing for obtaining time-domain channel responses.

10. The apparatus of claim 9, wherein to transmit the list of supported capabilities, the at least one processor, individually or in any combination, is configured to transmit the list of supported capabilities via a capability message.

11. The apparatus of claim 9, wherein the at least one processor, individually or in any combination, is further configured to:
receive, from the network entity based on the list of supported capabilities, an indication to apply at least one supported capability in the list of supported capabilities for the processing of the set of RS measurements, wherein the set of processing parameters is associated with the at least one supported capability.

12. The apparatus of claim 11, wherein to receive the indication, the at least one processor, individually or in any combination, is configured to receive the indication via a request location message.

13. The apparatus of claim 1, wherein the network entity is a location server or a location management function (LMF), and wherein the wireless device is a user equipment (UE) or a base station.

14. The apparatus of claim 1, wherein the index is associated with a set of indices and the set of processing parameters is associated with a plurality of sets of processing parameters, wherein different indices in the set of indices correspond to different sets of processing parameters in the plurality of sets of processing parameters.

15. A method of wireless communication at a wireless device, comprising:
processing a set of reference signal (RS) measurements based on a set of processing parameters to obtain a time-domain channel response associated with the set of RS measurements; and
transmitting, to a network entity, the time-domain channel response and an index indicative of the set of processing parameters.

16. An apparatus for wireless communication at a network entity, comprising:
at least one memory; and
at least one processor coupled to the at least one memory, the at least one processor, individually or in any combination, is configured to:
receive a time-domain channel response and an index, wherein the index is indicative of a set of processing parameters for processing a set of reference signal (RS) measurements to obtain the time-domain channel response; and
perform at least one of: (1) using the index as an additional input for at least one artificial intelligence (AI) or machine learning (ML) (AI/ML) model, (2) selecting, based on the index, one or more AI/ML models from a list of AI/ML models for training or inferencing, or (3) selecting or switching, based on the index, at least one layer in an AI/ML model.

17. The apparatus of claim 16, wherein the at least one processor, individually or in any combination, is further configured to:
transmit an indication that the time-domain channel response is used in association with AI/ML at the network entity, wherein reception of the index is based on the indication.

18. The apparatus of claim 16, wherein the set of processing parameters is related to proprietary or confidential information, and wherein the index is related to non-proprietary or non-confidential information.

19. The apparatus of claim 16, wherein the at least one processor, individually or in any combination, is further configured to:
receive information related the set of processing parameters, wherein the information is used as another additional input for the at least one AI/ML model, for selecting the one or more AI/ML models from the list of AI/ML models for the training or the inferencing, or for selecting or switching the at least one layer in the AI/ML model.

20. The apparatus of claim 19, wherein the information includes at least one of:
a sampling rate for the processing of the set of RS measurements,
a sampling period for the processing of the set of RS measurements,
a first indication of whether the sampling period is consistent with an RS bandwidth and subcarrier spacing (SCS), or
a second indication of whether a reported channel response is aligned with a sampling grid or is off-grid.

21. The apparatus of claim 16, wherein the set of processing parameters includes at least one of:
a first set of parameters related to oversampling,
a second set of parameters related to super resolution, or
a third set of parameters related to interpolation.

22. The apparatus of claim 16, wherein the at least one processor, individually or in any combination, is further configured to:
transmit, based on using the index, a request to process a second set of RS measurements using the set of processing parameters to obtain a second time-domain channel response; and
receive the second time-domain channel response.

23. The apparatus of claim 16, wherein the time-domain channel response includes at least one of:
a channel impulse response (CIR),
a power delay profile (PDP),
a delay profile (DP),
a first path measurement, or
an additional path measurement.

24. The apparatus of claim 16, wherein the at least one processor, individually or in any combination, is further configured to:
receive a list of supported capabilities related to RS processing for obtaining time-domain channel responses.

25. The apparatus of claim 24, wherein to receive the list of supported capabilities, the at least one processor, individually or in any combination, is configured to receive the list of supported capabilities via a capability message.

26. The apparatus of claim 24, wherein the at least one processor, individually or in any combination, is further configured to:
transmit, based on the list of supported capabilities, an indication to apply at least one supported capability in the list of supported capabilities for the processing of the set of RS measurements, wherein the set of processing parameters is associated with the at least one supported capability.

27. The apparatus of claim 26, wherein to transmit the indication, the at least one processor, individually or in any combination, is configured to transmit the indication via a request location message.

28. The apparatus of claim 16, wherein the network entity is a location server or a location management function (LMF).

29. The apparatus of claim 16, wherein the index is associated with a set of indices and the set of processing parameters is associated with a plurality of sets of processing parameters, wherein different indices in the set of indices correspond to different sets of processing parameters in the plurality of sets of processing parameters.

30. A method of wireless communication at a network entity, comprising:
receiving a time-domain channel response and an index, wherein the index is indicative of a set of processing parameters for processing a set of reference signal (RS) measurements to obtain the time-domain channel response; and
performing at least one of: (1) using the index as an additional input for at least one artificial intelligence (AI) or machine learning (ML) (AI/ML) model, (2) selecting, based on the index, one or more AI/ML models from a list of AI/ML models for training or inferencing, or (3) selecting or switching, based on the index, at least one layer in an AI/ML model.
